(19) United States
(12) Patent Application Publication
(10) Pub. No.: US 2022/0132607 A1
(43) Pub. Date: Apr. 28, 2022

(54) ROLE SWITCH HANDLING IN A MULTI CONNECTIVITY CONFIGURATION

(71) Applicant: Telefonaktiebolaget LM Ericsson (publ), Stockholm (SE)

(72) Inventors: Osman Nuri Can Yilmaz, Espoo (FI); Oumer Teyeb, Solna (SE); Patrik Rugeland, Stockholm (SE); Icaro Leonardo J. Da Silva, Solna (SE); Gunnar Mildh, Sollentuna (SE)

(21) Appl. No.: 17/430,936

(22) PCT Filed: Feb. 13, 2019
(86) PCT No.: PCT/EP2019/053539

§ 371 Date: Aug. 13, 2021

(51) Int. Cl. H04W 76/15; H04W 68/02

(52) U.S. Cl. CPC H04W 76/15; H04W 68/02

(57) ABSTRACT

A method performed by a network node for handling a multi connectivity configuration for a User Equipment (UE) resuming into connected mode from inactive mode in a wireless communications network is provided. The UE was multi connected to a first radio node and a second radio node before it entered into inactive mode. The network node receives a resume request from the UE. The network node then decides whether or not to trigger a role switch of any one or more out of: the first radio node and the second radio node for the multi connectivity configuration based on a certain condition. The role switch comprises any one out of: switching the role of the first radio node from Master Node, MN, to Secondary Node, SN, and switching the role of the second radio node from SN to MN.

### TECHNICAL FIELD

Embodiments herein relate to multi connectivity in a wireless communications network, specifically to handling a multi connectivity configuration for the UE resuming into connected mode from an inactive mode

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In 3GPP Dual-Connectivity (DC) solution has been specified, both for LTE and NR, as well as between LTE and NR. In DC two nodes are involved, a Master Node (MN) and a Secondary Node (SN). Multi-Connectivity (MC) is a case when there are more than two nodes involved. DC may also be used in Ultra Reliable Low Latency Communications (URLLC) cases in order to enhance the robustness and to avoid connection interruptions.

Inter-RAT and Inter 5GC in interworking LTE and NR:

5G in 3GPP introduces both a new core network (5GC) and a New Radio access network (NR). The 5GC will however, also support other RATs than NR. It has been agreed that LTE, here also referred to as E-UTRA, also will be connected to 5GC. LTE base stations referred to as eNBs, that are connected to 5GC are referred to as new generation-eNB (ng-eNBs) and is part of NG-RAN which also comprises NR base stations called gNBs. FIG. 1 depicts a 5G System (5GS) architecture comprising 5GC and NG-RAN. It shows how the base stations are connected to each other and the nodes in 5GC. The interface between the base stations are referred to as Xn. The interface between the base stations and core network nodes such as Access and Mobility Function (AMF)/User Plane Function (UPF) nodes and the core network are referred to as NG.

Currently in an LTE (E-UTRA) connected to the 5GC and NR state transitions are supported, see FIG. 2. FIG. 2 depicts UE state machine and state transitions between NR/5GC, E-UTRA/EPC and E-UTRA/5GC. A state machine is a system which may be in only one out of several finite of states at once, and state transitions is the transition between the one or more finite states of the state machine. e.g. which directions are allowed and how they are achieved.

As can be seen it is possible to move an ongoing UE connection wherein the UE is in RRC_CONNECTED state, between the two RATs using handover procedure. Additionally (not shown) it is possible for the network to move the UE to the other RAT by sending a Release message with re-direct information. When the UE is in RRC-IDLE or RRC-INACTIVE state the cell reselection procedure will be used when transiting between the RATs. Within the RATs there is also an RRC Re-establishment procedure which may be triggered if the UE loses the radio connection, referred to as Radio Link Failure, or at intra or inter-RAT handover failure.

In NR and E-UTRA, i.e. LTE connected to 5GC, a new RRC state called RRC_INACTIVE has been introduced. When used herein, NG-RAN refers to either NR or LTE connected to 5G Core (5GC) network.

In RRC_INACTIVE, the UE stores certain configurations, e.g. Radio Bearer (RB) configurations and physical layers parameters. When the UE need to resume the connection, it transmits an RRCConnectionResumeRequest or RRCResumeRequest message in LTE and NR respectively. The UE may then reuse the stored settings and reduce the time and signaling needed to enter RRC_CONNECTED.

LTE and NR/EPS and 5GS:

There are different ways to deploy 5G network with or without interworking with LTE and EPC, which is referred to as different options. In principle, NR and LTE may be deployed without any interworking, denoted by NR Stand-Alone (SA) operation, that is gNB in NR may be connected to 5GC (Option 1) and eNB may be connected to EPC (Option 1) with no interconnection between the two.

On the other hand, the first supported version of NR is the so-called E-UTRAN-NR Dual Connectivity (EN-DC), (Option 3). In Option 3, a deployment, dual connectivity between NR and LTE is applied with LTE as a master node and NR as a secondary node. The RAN node (gNB) supporting NR, may not have a control plane connection to EPC, instead it relies on the LTE as Master node (MeNB). This is also referred to as as Non-standalone NR. It should be noted that that in this case the functionality of an NR cell is limited and would be used for connected mode UEs as a booster and/or diversity leg, but an RRC_IDLE UE cannot camp on these NR cells.

With introduction of 5GC, other options may be also valid. As mentioned above, option 2 supports stand-alone NR deployment where gNB is connected to 5GC. Similarly, LTE may also be connected to 5GC using eLTE, E-UTRA/5GC, or LTE/5GC and the node may be referred to as an ng-eNB (Option 5). eLTE means that LTE is connected to 5GC.

In these cases, both NR and LTE are seen as part of the NG-RAN (and both the ng-eNB and the gNB can be referred to as NG-RAN nodes).

It is worth noting that, Option 4 and Option 7 are other variants of dual connectivity between LTE and NR which will be standardized as part of NG-RAN connected to 5GC, denoted by MR-DC (Multi-Radio Dual Connectivity). The following is comprised under the MR-DC umbrella:
EN-DC (Option 3): LTE is the master node and NR is the secondary (EPC CN employed)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the master and secondary are NR (5GCN employed).

As the migration for these options may differ from different operators, it is possible to have deployments with multiple options in parallel in the same network e.g. there may be an eNB base station supporting option 3, 5 and 7 in the same network as an NR base station supporting option 2 and 4. In combination with dual connectivity solutions between LTE and NR it is also possible to support Carrier Aggregation (CA) in each cell group, i.e.

Master Cell Group (MCG) and Secondary Cell Group (SCG), and dual connectivity between nodes on same RAT, e.g. NR-NR DC. For the LTE cells, a consequence of these different deployments is the co-existence of LTE cells associated to eNBs connected to EPC, 5GC or both EPC/5GC.

RRC Reconfiguration:

When a UE is in RRC_CONNECTED the network may decide that the UE should change its configurations, such as e.g. adding/modifying/releasing radio bearers, adding/changing measurement configurations, adding/modifying/releasing a secondary node or perform handover to another node. This may be performed by the network sends an RRCReconfiguration message to the UE, the UE may then respond to the network with an RRCReconfigurationComplete message.

In case of inter-node handover of a UE from a source node referred to as source gNB and a target node referred to as target gNB, will be different as can be seen in FIG. 3a illustrating handover preparation and handover execution, and FIG. 3b illustrating handover completion in an intra-AMF/UPF handover according to 3GPP TS 38.300.

The RAN Handover Initiation and the RAN Handover Completion are the RRCReconfiguration and the RRCReconfigurationComplete messages.

FIG. 3a, depicts Actions 1-8:
Action 0. The AMF provides mobility control information to the source gNB.
Action 1. Measurement control and reports are sent between the source gNB and the UE.
Action 2. Based on the measurement control and reports, the source gNB decides to perform a handover to the target gNB.
Action 3. The source gNB sends a handover request message to the target gNB.
Action 4. The target gNB performs admission control.
Action 5. The target gNB then sends a handover acknowledge message to the source gNB.
Action 6. The handover is then initiated.
Action 7. SN status is transferred from source gNB to target gNB that buffers User Data from the source gNB. Detach from old cell synchronises to the new cell in the UE, and the Source gNB delivers buffered data and new data from UPSs.
Action 8. RAN handover is completed.
FIG. 3b, Actions 9-12:
Action 9. The target gNB sends a path switch request message to the AMF.
Action 10. The path is then switched in the UPFs and an end marker is sent to the target gNB.
Action 11. The AMF sends a path switch request acknowledge message to the target gNB.
Action 12. The target gNB sends a UE context release message to the source gNB.

Inter-RAT Handover:

GERAN is an abbreviation for GSM Enhanced Data GSM Evolution (EDGE) Radio Access Network. In legacy E-UTRA, it was possible to perform inter-RAT handover to GERAN, UTRAN or Code Division Multiple Access (CDMA). This was performed by transmitting a MobilityFromEUTRACommand message containing a reconfiguration message applicable to the target RAT.

In 3GPP Release 15, this procedure was extended to allow inter-RAT handover from E-UTRA to NR, as well as inter-system handover between E-UTRA/EPC and E-UTRA/5GC, where the MobiltiyFromEUTRACommand message contains the RRCReconfiguration message if the target is NR or RRCConnectionReconfiguration message if the target is E-UTRA. In addition, a similar procedure was introduced in NR to allow handover from NR to E-UTRA/EPC or E-UTRA/5GC using the MobilityFromNRCommand message which contains the E-UTRA RRCConnectionReconfiguration message.

If a UE handovers from E-UTRA/EPC to E-UTRA/5GC or handover from E-UTRA/5GC to E-UTRA/EPC, it would receive the MobilityFromEUTRACommand message containing the RRCConnectionReconfiguration message.

If a UE handovers from E-UTRA/EPC to NR or handovers from E-UTRA/5GC to NR, it would receive the MobilityFromEUTRACommand message containing the RRCReconfiguration message.

If a UE handovers from NR to E-UTRA/EPC or handover from NR to E-UTRA/5GC, it would receive the MobilityFromNRCommand message containing the RRCConnectionReconfiguration message.

Background RRC Connection Resume in LTE:

In 3GPP LTE Release-13, a mechanism was introduced for the UE to be suspended by the network in a suspended state similar to RRC_IDLE but with the difference that the UE stores the Access Stratum (AS) context or RRC context. This makes it possible to reduce the signaling when the UE is becoming active again by resuming the RRC connection, instead of as prior to establish the RRC connection from scratch. Reducing the signaling could have several benefits:
Reduce latency e.g. for smart phones accessing Internet.
Reduced signaling leads to reduce battery consumption for machine type devices sending very little data.

The Release-13 solution is based on that the UE sends a RRCConnectionResumeRequest message to the network and in response may receive an RRCConnectionResume message from the network. The RRCConnectionResume message is not encrypted but integrity protected.

The resume procedure in LTE may be found in the 3GPP RRC specifications TS 36.331. As the UE performing resume is in RRC_IDLE (with suspended AS context), that triggers a transition from RRC_IDLE to RRC_CONNECTED. Hence, that is modelled in the specifications in the same subclause that captures the RRC connection establishment (subclause 5.3.3 RRC connection establishment).

Background RRC Connection Resume in NR and eLTE:

The RRC state model is updated in NR and in eLTE, i.e. LTE connected to 5GC, and a new RRC_INACTIVE state is introduced in addition to the existing RRC_IDLE and RRC_CONNECTED states inherited from LTE. In RRC_INACTIVE, the UE context from a previous RRC connection is stored in the RAN and is re-used the next time an RRC connection is established. The UE context includes information such as the UE security configuration, configured radio bearers etc. By storing the UE context in the RAN, the signaling required for security activation and bearer establishment is avoided, which is normally required when transitioning from RRC_IDLE to RRC_CONNECTED. This improves latency and reduces the signaling overhead.

A UE state machine and state transitions in NR is depicted in FIG. 4.

The NR RRC_INACTIVE mode is realized by introducing two new procedures RRC connection suspend, also called RRC connection release with Suspended Configuration (SuspendConfig) and “RRC connection resume. See FIG. 5. The gNB suspends a connection with UL and DL data transmissions and moves the UE from NR RRC_CONNECTED to NR RRC_INACTIVE by sending an RRCRelease message with suspend indication or configuration to the UE. This may happen for example after the UE has been inactive for a certain period which causes the gNB internal inactivity timer to expire. Both the UE and the gNB stores the UE context and the associated identifier, referred to as I-RNTI. It has been recently updated that two identifiers will be configured in the suspend configuration, a full and short I-RNTI. The one to be used in resume depends on an indication from the network in system information of the cell the UE tries to resume in. The two I-RNTI identifiers were introduced to support scenarios when the UE is resuming in a cell which only gives the UE a small scheduling grant for the first UL message. For this purpose, also two different resume messages have been introduced namely RRCResumeRequest and RRCResumeRequest1. In the remainder of this document RRC resume request is used to refer to both messages.

At the next transition to NR RRC_CONNECTED, the UE resumes the connection by sending an RRC resume request including the following information to the gNB which the UE attempts to resume the connection towards. It should be noted that it may be another cell/gNB compared to the cell/gNB where the connection was suspended.
The I-RNTI, either the full or short I-RNTI depending on the system information indication.
A security token, referred to as resumeMAC-I in the specification, which is used to identify and verify the UE at RRC connection resume.
An indication of the cause of the resume, e.g. mobile originated data.

The gNB which serves the cell in which the UE is resuming is sometimes referred to as the target gNB, while the gNB serving the cell in which the UE was suspended in is sometimes referred to as the source gNB. To resume the connection, the target gNB determines which gNB is the source gNB, considering the gNB part of the I-RNTI, and request that gNB to send the UE's context. In the request the target provides, among other things, the UE ID and security token received from the UE as well as the target cell Cell ID.

The source gNB then locates the UE context based on the I-RNTI and verifies the request based on the security token, see next section. If successful, the gNB forwards the UE context to the target gNB, which then responds to the UE with RRC resume to confirm the connection is being resumed. The RRC resume message may also comprise configurations to reconfigure the radio bearers being resumed. Finally, the UE acknowledges the reception of the RRC re-establishment by sending RRC re-establishment complete. See FIG. 6.

It should be noted that the described NR RRC resume procedure works in a similar way in LTE and eLTE, i.e. when LTE is connected to 5GC.

In NR and in eLTE which means LTE connected to 5GC, the RRCResume message is encrypted and integrity protected. That is done using new security keys, derived based on the stored AS security context. This new key derivation (sort of a key update) is done as part of the resume procedure, in particular as part of the transmission of the RRCResumeRequest (or RRCResumeRequest1) message.

It is not only the RRCResume message that may be sent in response to the RRCResumeRequest message.

In NR and eLTE, after the UE sends an RRC Resume Request kind of message, e.g. RRCResumeRequest message or RRCResumeRequest1 message, the UE may receive a message on SRB1 that should also be encrypted, and integrity protected, as described above:

RRCRelease with suspend configuration moving the UE to RRC_INACTIVE;

RRCRelease without suspend configuration moving the UE to RRC_IDLE;

RRCResume moving the UE to RRC_CONNECTED;

Other messages may also be transmitted, an RRCReject message with wait timer or RRCSetup message (fallback to RRC_IDLE) but on SRB0, i.e. not encrypted or integrity protected. SRB0 is for RRC messages using the CCCH logical channel. CCCH is the Common Control CHannel which is an unprotected channel used by many UEs. SRB1 is for RRC messages, which may include a piggybacked NAS message, as well as for NAS messages prior to the establishment of SRB2, all using DCCH logical channel. DCCH is the Dedicated Control CHannel which is protected and is dedicated to a specific UE. All these possible responses are shown as follows in the specifications:

FIG. 7a depicts a scenario of a RRC connection resume, successful. In this scenario the UE sends an RRCResumeRequest message to the Network. The network then sends a RRCResume message to the UE which responds to the network with a RRCResumeComplete message.

FIG. 7b depicts a scenario of a RRC connection resume fallback to RRC connection establishment, successful. In this scenario the UE sends an RRCResumeRequest message to the Network. The network then sends a RRCSetup message to the UE which responds to the network with a RRCSetupComplete message.

FIG. 7c depicts a scenario of an RRC connection resume followed by network release, successful. In this scenario the UE sends an RRCResumeRequest message to the Network. The network then sends an RRCRelease message to the UE.

FIG. 7d depicts a scenario of an RRC connection resume followed by network suspend, successful. In this scenario the UE sends an RRCResumeRequest message to the Network. The network then sends an RRCRelease with suspend configuration message to the UE.

FIG. 7e depicts a scenario of an RRC connection resume, network reject. In this scenario the UE sends an RRCResumeRequest message to the Network. The network then sends an RRCReject message to the UE.

Dc Operations:

The general operations related to MR-DC are captured in 3GPP TS 37.340. The ones related to MR-DC with 5GC are reproduced in this sectionFor EN-DC procedures slightly differing can be found in clause 10 from 3GPP TS 37.340.

Secondary Node Addition:

The Secondary Node (SN) Addition procedure is initiated by the MN and is used to establish a UE context at the SN in order to provide radio resources from the SN to the UE. For bearers requiring SCG radio resources, this procedure is used to add at least the initial SCG serving cell of the SCG. This procedure may also be used to configure an SN terminated MCG bearer, where no SCG configuration is needed. FIG. 8 depicts actions 1-12 of an SN Addition procedure. FIG. 8 which corresponds to FIG. 10.2.2-1 in the 3GPP specification shows the SN Addition procedure.

Action 1: The MN decides to request the target SN to allocate radio resources for one or more specific PDU Sessions and/or Quality of Service (QoS) Flows, indicating QoS Flows characteristics (QoS Flow Level QoS parameters, PDU session level TNL address information, and PDU session level Network Slice info). In addition, for bearers requiring SCG radio resources, MN indicates the requested SCG configuration information, including the entire UE capabilities and the UE capability coordination result. In this case, the MN also provides the latest measurement results for SN to choose and configure the SCG cell(s). The MN may request the SN to allocate radio resources for split SRB operation. The MN always provides all the needed security information to the SN (even if no SN terminated bearers are setup) to enable SRB3 to be setup based on SN decision. SRB3 is for specific RRC messages when the UE is in EN-DC, all using DCCH logical channel, this will soon also comprise the other MR-DC options, not only EN-DC. SRB3 is directly between the SN and the UE, while SRB0, SRB1 and SRB2 is between the MN and the UE. For bearer options that require Xn-U resources between the MN and the SN, MN needs to provide Xn-U TNL address information, Xn-U DL TNL address information for SN terminated bearers and Xn-U UL TNL address information for MN terminated bearers. The SN may reject the request.

NOTE 1: For split bearers, MCG and SCG resources may be requested of such an amount, that the QoS for the respective QoS Flow is guaranteed by the exact sum of resources provided by the MCG and the SCG together, or even more. For MN terminated split bearers, the MN decision is reflected in action 1 by the QoS Flow parameters signalled to the SN, which may differ from QoS Flow parameters received over NG.

NOTE 2: For a specific QoS flow, the MN may request the direct establishment of SCG and/or split bearers, i.e. without first having to establish MCG bearers. It is also allowed that all QoS flows can be mapped to SN terminated bearers, i.e. there is no QoS flow mapped to an MN terminated bearer.

Action 2: If the RRM entity in the SN is able to admit the resource request, it allocates respective radio resources and, dependent on the bearer type options, respective transport network resources. For bearers requiring SCG radio resources the SN triggers UE Random Access so that synchronisation of the SN radio resource configuration may be performed. The SN decides for the PSCell and other SCG SCells and provides the new SCG radio resource configuration to the MN in a SN RRC configuration message contained in the SN Addition Request Acknowledge message. In case of bearer options that require Xn-U resources between the MN and the SN, the SN provides Xn-U TNL address information for the respective E-RAB, Xn-U UL TNL address information for SN terminated bearers, Xn-U DL TNL address information for MN terminated bearers. For SN terminated bearers, the SN provides the NG-U DL TNL address information for the respective PDU Session and security algorithm. If SCG radio resources have been requested, the SCG radio resource configuration is provided.

NOTE 3: In case of MN terminated bearers, transmission of user plane data may take place after action 2.

NOTE 4: In case of SN terminated bearers, data forwarding and the SN Status Transfer may take place after action 2.

NOTE 5: For MN terminated NR SCG bearers for which Packet Data Convergence Protocol (PDCP) duplication with CA is configured the MN allocates 2 separate Xn-U bearers.

For SN terminated NR MCG bearers for which PDCP duplication with CA is configured the SN allocates 2 separate Xn-U bearers.

Action 3: The MN sends the MN RRC reconfiguration message to the UE including the SN RRC configuration message, without modifying it.

Action 4: The UE applies the new configuration and replies to MN with MN RRC reconfiguration complete message, including a SN RRC response message for SN, if needed. In case the UE is unable to comply with (part of) the configuration included in the MN RRC reconfiguration message, it performs the reconfiguration failure procedure.

Action 5. The MN informs the SN that the UE has completed the reconfiguration procedure successfully via SN Reconfiguration Complete message, including the encoded SN RRC response message, if received from the UE.

Action 6. If configured with bearers requiring SCG radio resources, the UE performs synchronisation towards the PSCell configured by the SN. The order the UE sends the MN RRC reconfiguration complete message and performs the Random Access procedure towards the SCG is not defined. The successful RA procedure towards the SCG is not required for a successful completion of the RRC Connection Reconfiguration procedure.

Action 7: In case of SN terminated bearers using RLC AM, the MN sends SN Status Transfer.

Action 8: In case of SN terminated bearers using RLC AM, and dependent on the bearer characteristics of the respective QoS Flows, the MN may take actions to minimise service interruption due to activation of MR-DC (Data forwarding).

Actions 9-12: For SN terminated bearers, the update of the UP path towards the 5GC is performed via PDU Session Path Update procedure.

Secondary Node Modification (MN/SN Initiated):

The SN Modification procedure may be initiated either by the MN or by the SN and may be used to modify, establish or release PDU session/QoS Flow contexts, to transfer PDU session and/or QoS Flow contexts to and from the SN or to modify other properties of the UE context within the same SN. It may also be used to transfer an NR RRC message from the SN to the UE via the MN and the response from the UE via MN to the SN, e.g. when SRB3 is not used.

The SN modification procedure does not necessarily need to involve signalling towards the UE.

MN Initiated SN Modification:

FIG. 9 depicts an SN Modification procedure which is MN initiated. The MN uses the procedure to initiate configuration changes of the SCG within the same SN, including addition, modification or release PDU session/QoS Flows mapped onto SN terminated bearer(s) and MN terminated bearers with an SCG RLC bearer. The MN uses the procedure to query the current SCG configuration, e.g. when delta configuration is applied in a MN initiated SN change. The MN uses the procedure to provide the Secondary (S)-Radio Link Failure (RLF) related information to the SN. The MN may not use the procedure to initiate the addition, modification or release of SCG Scells. The SN may reject the request, except if it concerns the release of PDU session/QoS flow. FIG. 9 which corresponds to FIG. 10.3.2-1 in the 3GPP specification, shows an example signalling flow for a MN initiated SN Modification procedure.

Action 1: The MN sends the SN Modification Request message, which may contain PDU session, and/or QoS Flow context related or other UE context related information, data forwarding address information if applicable, PDU session level Network Slice information and the requested SCG configuration information, including the UE capabilities coordination result to be used as basis for the reconfiguration by the SN.

Action 2: The SN responds with the SN Modification Request Acknowledge message, which may contain new SCG radio configuration information within a SN RRC configuration message, and data forwarding address information if applicable.

NOTE: For MN terminated NR SCG bearers to be setup for which PDCP duplication with CA is configured the MN allocates 2 separate Xn-U bearers. Xn-U stands for Xn User Plane interface.

For SN terminated NR MCG bearers to be setup for which PDCP duplication with CA is configured the SN allocates 2 separate Xn-U bearers.

Actions 3/4: The MN initiates the RRC connection reconfiguration procedure, including SN RRC configuration message. The UE applies the new configuration and replies with MN RRC reconfiguration complete message, including a SN RRC response message, if needed. In case the UE is unable to comply with (part of) the configuration included in the MN RRC reconfiguration message, it performs the reconfiguration failure procedure.

Action 5: Upon successful completion of the reconfiguration, the success of the procedure is indicated in the SN Reconfiguration Complete message.

Action 6: If instructed, the UE performs synchronisation towards the PSCell of the SN as described in SN addition procedure. Otherwise, the UE may perform UL transmission after having applied the new configuration.

Action 7: If PDCP termination point is changed for bearers using RLC AM, and when RRC full configuration is not used, the MN sends the SN Status transfer.

Action 8: If applicable, data forwarding between MN and the SN takes place. FIG. 9 depicts the case where a PDU session/QoS Flow context is transferred from the MN to the SN.

Action 9: If applicable, a PDU Session path update procedure is performed.

SN Initiated SN Modification with MN Involvement

FIG. 10 which corresponds to FIG. 10.3.2-2 in the 3GPP specification depicts an SN Modification procedure which is SN initiated with MN involvement. The SN uses the procedure to perform configuration changes of the SCG within the same SN, e.g. to trigger the modification/release of PDU session and/or QoS flows and to trigger PSCell changes, when MN involvement is needed for this. The MN cannot reject the release request of PDU session/QoS flows. FIG. 10 shows an example signalling flow for SN initiated SN Modification procedure.

Action 1: The SN sends the SN Modification Required message including a SN RRC configuration message, which may contain PDU session and/or QoS Flow context related, other UE context related information and the new radio resource configuration of SCG. For the release or modification of PDU session/QoS flow, a corresponding PDU session and/or QoS Flows list is included in the SN Modification Required message.

The SN may decide whether the change of security key is required.

Actions 2/3: The MN initiated SN Modification procedure may be triggered by SN Modification Required message.

Action 4: The MN sends the MN RRC reconfiguration message to the UE including the SN RRC configuration message the new SCG radio resource configuration.

Action 5: The UE applies the new configuration and sends the MN RRC reconfiguration complete message, including an encoded SN RRC response message, if needed. In case the UE is unable to comply with (part of) the configuration included in the MN RRC reconfiguration message, it performs the reconfiguration failure procedure.

Action 6: Upon successful completion of the reconfiguration, the success of the procedure is indicated in the SN Modification Confirm message containing the encoded SN RRC response message, if received from the UE.

Action 7: If instructed, the UE performs synchronisation towards the PSCell configured by the SN as described in SN Addition procedure. Otherwise, the UE may perform UL transmission directly after having applied the new configuration.

Action 8: If PDCP termination point is changed for bearers using RLC AM, and when RRC full configuration is not used, the SN sends the MN Status transfer.

Action 9: If applicable, data forwarding between MN and the SN takes place (FIG. 10.3.2-2 depicts the case where a PDU session/QoS Flow context is transferred from the SN to the MN).

Action 10: If applicable, a PDU Session path update procedure is performed.

SN Initiated SN Modification without MN Involvement

FIG. 11 which corresponds to FIG. 10.3.2-3 in the 3GPP specification depicts an SN Modification which is SN initiated without MN involvement. This procedure is not supported for NE-DC. The SN initiated SN modification procedure without MN involvement is used to modify the configuration within SN in case no coordination with MN is required, including the addition/modification/release of SCG Scell and PSCell change when MN involvement is not needed for this. FIG. 11 shows an example signalling flow for SN initiated SN modification procedure without MN involvement. The SN may decide whether the Random Access procedure is required.

Action 1. The SN sends the SN RRC reconfiguration message to the UE through SRB3.

Action 2. The UE applies the new configuration and replies with the SN RRC reconfiguration complete message. In case the UE is unable to comply with (part of) the configuration included in the SN RRC reconfiguration message, it performs the reconfiguration failure procedure.

Action 3. If instructed, the UE performs synchronisation towards the PSCell of the SN as described in SN Addition procedure. Otherwise the UE may perform UL transmission after having applied the new configuration.

Transfer of an NR RRC message to/from the UE when SRB3 is not used FIG. 12 which corresponds to FIG. 10.3.2-4 in the 3GPP specification depicts a Transfer of an NR RRC message to and from the UE. The SN initiates the procedure when it needs to transfer an NR RRC message to the UE and SRB3 is not used.

Action 1. The SN initiates the procedure by sending the SN Modification Required to the MN.

Action 2. The MN forwards the NR RRC message to the UE in the RRC reconfiguration message.

Action 3. The UE applies the new configuration and replies with the RRC reconfiguration complete message.

Action 4. The MN forwards the NR RRC response message, if received from the UE, to the SN in the SN Modification Confirm message.

Action 5. If instructed, the UE performs synchronization towards the PSCell of the SN as described in SN Addition procedure. Otherwise the UE may perform UL transmission after having applied the new configuration.

Dual Connectivity for Intra-NR Handover

A dual connectivity based intra-NR handover has been proposed for performing a Oms handover. The principle is illustrated in FIG. 13 that depicts Dual connectivity with role change. The procedure involves 3 main steps:

Step 1. The gNB of target cell is added as an S-gNB.

Step 2. A role change is performed between the M-gNB and the S-gNB, i.e. master node becomes secondary and vice versa.

Step 3. The S-gNB is released.

RRC Message Structures

In the section below, the structure of the messages, reconfiguration and resume and

also related Information Elements (IEs) are shown.

NR RRCReconfiguration Message:

-- ASN1START
-- TAG-RRCRECONFIGURATION-START

| | |
|---|---|
| RRCReconfiguration ::= | SEQUENCE { |

| | |
|---|---|
| rrc-TransactionIdentifier | RRC- |

TransactionIdentifier,

| | |
|---|---|
| criticalExtensions | CHOICE { |

rrcReconfiguration
RRCReconfiguration-IEs,

| | |
|---|---|
| criticalExtensionsFuture | SEQUENCE { } |

}
}

| | |
|---|---|
| RRCReconfiguration-IEs ::= | SEQUENCE { |

radioBearerConfig
RadioBearerConfig

| | |
|---|---|
| OPTIONAL, | -- Need M |

| | |
|---|---|
| secondaryCellGroup | OCTET STRING |

(CONTAINING CellGroupConfig)

| | |
|---|---|
| OPTIONAL, | -- Need M |

| | |
|---|---|
| measConfig | MeasConfig |

| | |
|---|---|
| OPTIONAL, | -- Need M |

| | |
|---|---|
| lateNonCriticalExtension | OCTET STRING |

OPTIONAL,
nonCriticalExtension
RRCReconfiguration-v1530-IEs
OPTIONAL
}

| | |
|---|---|
| RRCReconfiguration-v1530-IEs ::= | SEQUENCE { |
| masterCellGroup | OCTET STRING |

(CONTAINING CellGroupConfig)

| | |
|---|---|
| OPTIONAL, | -- Need M |

| | |
|---|---|
| fullConfig | ENUMERATED |

{true}

| | |
|---|---|
| OPTIONAL, | -- Cond FullConfig |

| | |
|---|---|
| dedicatedNAS-MessageList | SEQUENCE |

(SIZE (1..maxDRB)) OF DedicatedNAS-Message

| | |
|---|---|
| OPTIONAL, | -- Cond nonHO |

| | |
|---|---|
| masterKeyUpdate | MasterKeyUpdate |

| | |
|---|---|
| OPTIONAL, | -- Cond MasterKeyChange |

| | |
|---|---|
| dedicatedSIB1-Delivery | OCTET STRING |

(CONTAINING SIB1)

| | |
|---|---|
| OPTIONAL, | -- Need N |

| | |
|---|---|
| dedicatedSystemInformationDelivery | OCTET STRING |

(CONTAINING SystemInformation)

| | |
|---|---|
| OPTIONAL, | -- Need N |

| | |
|---|---|
| otherConfig | OtherConfig |

| | |
|---|---|
| OPTIONAL, | -- Need N |

nonCriticalExtension
RRCReconfiguration-v15xy-IEs
OPTIONAL
}

| | |
|---|---|
| RRCReconfiguration-v15xy-IEs ::= | SEQUENCE { |

| | |
|---|---|
| mrdc-SecondaryCellGroup | CHOICE { |

| | |
|---|---|
| nr-SCG | OCTET STRING, |
| eutra-SCG | OCTET STRING |

}

| | |
|---|---|
| OPTIONAL, | -- Need M |

| | |
|---|---|
| radioBearerConfig2 | OCTET STRING |

(CONTAINING RadioBearerConfig)

| | |
|---|---|
| OPTIONAL. | -- Need M |

| | |
|---|---|
| sk-Counter | INTEGER |

(0..65535)

| | |
|---|---|
| OPTIONAL, | -- Cond S-KeyChange |

| | |
|---|---|
| nonCriticalExtension | SEQUENCE { } |

OPTIONAL
}

| | |
|---|---|
| MasterKeyUpdate ::= | SEQUENCE { |
| keySetChangeIndicator | BOOLEAN, |
| nextHopChainingCount | NextHopChainingCount, |
| nas-Container | OCTET STRING |

```
    OPTIONAL, -- Cond securityNASC
  ...
}
```

The information elements underlined above are described below.

RadioBearerConfig: This is the IE that holds the configuration of the radio bearers (DRBs and SRBs). A UE may have two radio bearer configurations (radioBearerConfig and radioBearerConfig2). radioBeaerConfig2 is usually used when the UE is in DC, but it can be used even before the UE is standalone mode (i.e. to prepare for a DC). The radioBearerConfig and radioBearerConfig2 are mainly distinguished by the security configuration (keys, algorithms) used by the PDCP. Normally, radioBearerConfig holds the configuration of the bearers associated with the master key while radioBearerConfig2 holds the configuration of the bearers associated with the secondary key. However, it is up to the network to decide which IE to associate to which key, because the radio bearer configuration contains the key to use as well (i.e. radioBearerConfig2 can be associated with the secondary key). The structure of the RadioBearerConfig is shown below:

| -- ASN1START | |
|---|---|
| -- TAG-RADIO-BEARER-CONFIG-START | |
| RadioBearerConfig ::= | SEQUENCE { |
| srb-ToAddModList | SRB-ToAddModList |

| | |
|---|---|
| OPTIONAL, | -- Cond HO-Conn |

| | |
|---|---|
| srb3-ToRelease | ENUMERATED{true} |

| | |
|---|---|
| OPTIONAL, | -- Need N |

| | |
|---|---|
| drb-ToAddModList | DRB-ToAddModList |

| | |
|---|---|
| OPTIONAL, | -- Cond HO-toNR |

| | |
|---|---|
| drb-ToReleaseList | DRB- |

| ToReleaseList | |
|---|---|
| OPTIONAL, | -- Need N |

| | |
|---|---|
| securityConfig | SecurityConfig |

| | |
|---|---|
| OPTIONAL, | -- Need M |

| ... | |
|---|---|
| } | |
| SRB-ToAddModList ::= | SEQUENCE (SIZE |
| (1..2) ) OF SRB-ToAddMod | |
| SRB-ToAddMod ::= | SEQUENCE { |
| srb-Identity | SRB-Identity, |
| reestablishPDCP | ENUMERATED{true} |

| | |
|---|---|
| OPTIONAL, | -- Need N |

| | |
|---|---|
| discardOnPDCP | ENUMERATED{true} |

| | |
|---|---|
| OPTIONAL, | -- Need N |

| | |
|---|---|
| pdcp-Config | PDCP-Config |

| | |
|---|---|
| OPTIONAL, | -- Cond PDCP |

| ... | |
|---|---|
| } | |
| DRB-ToAddModList ::= | SEQUENCE (SIZE |
| (1..maxDRB)) OF DRB-ToAddMod | |
| DRB-ToAddMod ::= | SEQUENCE { |
| cnAssociation | CHOICE { |
| eps-BearerIdentity | INTEGER |
| (0..15), | -- EPS-DRB-Setup |
| sdap-Config | SDAP-Config |
| -- 5GC | |
| } | OPTIONAL, -- |
| Cond DRBSetup | |
| drb-Identity | DRB-Identity, |
| reestablishPDCP | ENUMERATED{true} |

| | |
|---|---|
| OPTIONAL, | -- Need N |

| | |
|---|---|
| recoverPDCP | ENUMERATED{true} |

| | |
|---|---|
| OPTIONAL, | -- Need N |

| | |
|---|---|
| pdcp-Config | PDCP-Config |

| | |
|---|---|
| OPTIONAL, | -- Cond PDCP |

| ... | |
|---|---|
| } | |
| DRB-ToReleaseList ::= | SEQUENCE (SIZE |
| (1..maxDRB)) OF DRB-Identity | |
| SecurityConfig ::= | SEQUENCE { |

| securityAlgorithmConfig | |
|---|---|
| SecurityAlgorithmConfig | |
| OPTIONAL, | -- Cond RBTermChange |
| keyToUse | |
| ENUMERATED{master, secondary} | |
| OPTIONAL, | -- Cond RBTermChange |

...
}

sk-counter: is an integer that is used to derive the secondary key. When the UE is configured with DC (or pre-prepared for DC), the sk-counter is provided to it, and it derives the secondary key based on that. From the secondary key, and the indicated algorithms in the SecurityConfig included in the radioBearerConfig, the encryption and integrity protection keys are derived and the PDCPs of all the radio bearers associated with the secondary key will use these keys to perform encryption/decryption and integrity protection/verification.

mastercellGroup: This includes the lower layer (RLC, MAC, PHY) configuration during standalone configuration, and also for the master leg during a DC setup.

mrdc-SecondaryCellGroup: This includes the lower layer configuration for the secondary cell group when DC is configured. For the case of NE-DC, this will include eutra-SCG, while for the case of NR-DC, it will include the NR cell group configuration.

In the case of EN-DC, NR is the secondary cell group and for this case, the IE secondaryCellGroup is used (i.e. the master cell group in this case will be an EUTRA cell group and is provided to the UE via the LTE RRCConnectionReconfiguration message)

The structure of the cell group config IE is shown below (cellGroupID of 0 indicates the master cell):

CellGroupConfig Information Element

-- ASN1START
-- TAG-CELL-GROUP-CONFIG-START
-- Configuration of one Cell-Group:

| | |
|---|---|
| CellGroupConfig ::= | SEQUENCE { |
| cellGroupId | CellGroupId, |
| rlc-BearerToAddModList | SEQUENCE |

(SIZE(1..maxLC-ID)) OF RLC-BearerConfig

| | |
|---|---|
| OPTIONAL, | -- Need N |

| | |
|---|---|
| rlc-BearerToReleaseList | SEQUENCE |

(SIZE(1..maxLC-ID)) OF LogicalChannelIdentity

| | |
|---|---|
| OPTIONAL, | -- Need N |

| | |
|---|---|
| mac-CellGroupConfig | MAC- |

CellGroupConfig

| | |
|---|---|
| OPTIONAL, | -- Need M |

physicalCellGroupConfig
PhysicalCellGroupConfig

| | |
|---|---|
| OPTIONAL, | -- Need M |

| | |
|---|---|
| spCellConfig | SpCellConfig |

| | |
|---|---|
| OPTIONAL, | -- Need M |

| | |
|---|---|
| sCellToAddModList | SEQUENCE |

(SIZE (1..maxNrofSCells)) OF SCellConfig

| | |
|---|---|
| OPTIONAL, | -- Need N |

| | |
|---|---|
| sCellToReleaseList | SEQUENCE |

(SIZE (1..maxNrofSCells)) OF SCellIndex

| | |
|---|---|
| OPTIONAL, | -- Need N |

```
  ...,
  [[
```

| | |
|---|---|
| reportUplinkTxDirectCurrent-v1530 | ENUMERATED |

{true}

| | |
|---|---|
| OPTIONAL | -- Cond BWP-Reconfig |

]]
}
-- Serving cell specific MAC and PHY parameters for a
SpCell:

| | |
|---|---|
| SpCellConfig ::= | SEQUENCE { |
| servCellIndex | ServCellIndex |

| | |
|---|---|
| OPTIONAL, | -- Cond SCG |

reconfigurationWithSync
ReconfigurationWithSync

| | |
|---|---|
| OPTIONAL, | -- Cond ReconfWithSync |

| | |
|---|---|
| rlf-TimersAndConstants | SetupRelease { RLF- |

TimersAndConstants }

| | |
|---|---|
| OPTIONAL, | -- Need M |

| | |
|---|---|
| rlmInSyncOutOfSyncThreshold | ENUMERATED {n1} |

| | |
|---|---|
| OPTIONAL, | -- Need S |

| | |
|---|---|
| spCellConfigDedicated | ServingCellConfig |

| | |
|---|---|
| OPTIONAL, | -- Need M |

...
}

| | |
|---|---|
| ReconfigurationWithSync ::= | SEQUENCE { |

spCellConfigCommon
ServingCellConfigCommon

| | |
|---|---|
| OPTIONAL, | -- Need M |

| | |
|---|---|
| newUE-Identity | RNTI-Value, |
| t304 | ENUMERATED {ms50, |

ms100, ms150, ms200, ms500, ms1000, ms2000, ms10000},

| rach-ConfigDedicated | | CHOICE { |
|---|---|---|
| | uplink | RACH- |

ConfigDedicated,

| | |
|---|---|
| supplementaryUplink | RACH- |

ConfigDedicated
}

| | |
|---|---|
| OPTIONAL, | -- Need N |

```
  ...,
  [[
```

| | |
|---|---|
| smtc | SSB-MTC |

| | |
|---|---|
| OPTIONAL | -- Need S |

]]
}

| | |
|---|---|
| SCellConfig ::= | SEQUENCE { |
| sCellIndex | SCellIndex, |

sCellConfigCommon
ServingCellConfigCommon

| | |
|---|---|
| OPTIONAL, | -- Cond SCellAdd |

| | |
|---|---|
| sCellConfigDedicated | ServingCellConfig |

| | |
|---|---|
| OPTIONAL, | -- Cond SCellAddMod |

```
  ...,
  [[
```

| | |
|---|---|
| smtc | SSB-MTC |

| | |
|---|---|
| OPTIONAL | -- Need S |

]]
}
-- TAG-CELL-GROUP-CONFIG-STOP
-- ASN1STOP

The structure of the RRCResume message is shown below:

| -- ASN1START | |
|---|---|
| -- TAG-RRCRESUME-START | |
| RRCResume ::= | SEQUENCE { |
| rrc-TransactionIdentifier | RRC- |
| TransactionIdentifier, | |
| criticalExtensions | CHOICE { |
| rrcResume | RRCResume-IEs, |
| criticalExtensionsFuture | SEQUENCE { } |
| } | |
| } | |
| RRCResume-IEs ::= | SEQUENCE { |
| radioBearerConfig | RadioBearerConfig |

| | |
|---|---|
| OPTIONAL, | -- Need M |

| | |
|---|---|
| masterCellGroup | OCTET STRING |

| (CONTAINING CellGroupConfig) | |
|---|---|
| OPTIONAL, | -- Need M |

| | |
|---|---|
| measConfig | MeasConfig |

| | |
|---|---|
| OPTIONAL, | -- Need M |

| | |
|---|---|
| fullConfig | ENUMERATED {true} |

| | |
|---|---|
| OPTIONAL, | -- Need N |

| lateNonCriticalExtension | OCTET STRING |
|---|---|
| OPTIONAL, | |
| nonCriticalExtension | RRCResume-v15xx-IEs |
| OPTIONAL | |
| } | |
| RRCResume-v15xx-IEs ::= | SEQUENCE { |
| radioBearerConfig2-r15x | OCTET STRING |

| (CONTAINING RadioBearerConfig) | |
|---|---|
| OPTIONAL, | -- Need M |

| | |
|---|---|
| sk-Counter-r15x | INTEGER (0..65535) |

| | |
|---|---|
| OPTIONAL, | -- Need N |

| | |
|---|---|
| mrde-SecondaryCellGroup | CHOICE { |
| nr-SCG | OCTET STRING, |
| eutra-SCG | OCTET STRING |

| } | |
|---|---|
| OPTIONAL, | -- Need M |

| | |
|---|---|
| nonCriticalExtension | SEQUENCE{ } |

OPTIONAL
}

It should be noted that the NR specification is still evolving and the RRCReconfiguration and RRCResume messages shown above are not exactly the ones that can be found in the agreed specifications right now. For example, as of this writing, neither the reconfiguration nor the resume message contain the mrdc-SecondaryCellGroup field. It is assumed that these will be introduced in the upcoming versions and the names that will be used in the specifications might end up being different.

When a UE that was in MR-DC mode is suspended and is resumed, the UE may have moved to another location or the network conditions might have changed, which could make it sub-optimal to resume with the same MN and SN nodes as before suspension. Some examples comprise:
The UE has moved during inactive state and the conditions, e.g. the radio conditions, with the SN are better than the MN.
The UE is now outside the coverage area of the MN but still inside the SN
The UE is outside the coverage area of the SN but still inside the coverage of the MN when resuming, however there is another node towards which the UE has a more favorable radio conditions and is more suitable for the new MN role.

Thus, resuming with the same DC configuration as before suspension may result in unnecessary reconfiguration and/or handover immediately after resumption.

As mentioned above, MN-SN role change has been discussed in 3GPP to provide a 0 ms handover interruption. However, there is no solution the MN-SN role change when the UE is returning from RRC_INACTIVE using the Resume procedure. The execution of the role switch is different in the embodiments provided herein, e.g. using modification of the resume procedure not the handover procedure, and the motivation and problem statement for doing the role switch is different, e.g. to reduce latency and/or signaling, and not to handle handover with 0 ms interruption.

### SUMMARY

An object of embodiments herein is to improve the performance of a communications network using multi connectivity configurations.

This object is achieved by the independent claims. Advantageous embodiments are described in the dependent claims and by the following description.

An embodiment concerns a method performed by a network node for handling a multi connectivity configuration for a User Equipment, UE, resuming into connected mode from inactive mode in a wireless communications network, wherein the UE was multi connected to a first radio node and a second radio node before it entered into inactive mode, comprising:

receiving a resume request from the UE,

deciding whether or not to trigger a role switch of any one or more out of: the first radio node and the second radio node for the multi connectivity configuration based on a certain condition.

The role switch may comprise: switching the role of the first radio node from Master Node, MN, to Secondary Node, SN, and/or switching the role of the second radio node from SN to MN.

Another embodiment concerns a method performed by a User Equipment, UE, for handling a multi connectivity configuration when resuming into connected mode from inactive mode in a wireless communications network, wherein the UE was multi connected to a first radio node and a second radio node before it entered into inactive mode, comprising:

sending a resume request message to a network node serving the UE,

receiving an indication from the network node, indicative of a role switch of any one or more out of the radio first node and the second radio node in the multi connectivity configuration.

The role switch may comprise:

switching the role of the first radio node from Master Node, MN, to Secondary Node, SN, and/or switching the role of the second radio node from SN to MN.

Another embodiment concerns a network node configured to handle a multi connectivity configuration for a User Equipment, UE, adapted to resume into connected mode from inactive mode in a wireless communications network, comprising:

receiving a resume request from the UE 120,

deciding whether or not to trigger a role switch of any one or more out of:

the first radio node and the second radio node for the multi connectivity configuration based on a certain condition.

The role switch may comprise switching the role of the first radio node from Master Node, MN, to Secondary Node, SN, and/or switching the role of the second radio node from SN to MN.

Another embodiment concerns a User Equipment, UE, configured to handle a multi connectivity configuration to resume into connected mode from inactive mode in a wireless communications network, comprising
sending a resume request message to a network node serving the UE,
receiving an indication from the network node, which indication indicates a role switch of any one or more out of the radio first node and the second radio node in the multi connectivity configuration.

The role switch may comprise switching the role of the first radio node from Master Node, MN, to Secondary Node, SN, and/or switching the role of the second radio node from SN to MN.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3a-b is a sequence diagram illustrating prior art.

FIG. 4 is a schematic block diagram illustrating prior art.

FIG. 5 is a sequence diagram illustrating prior art.

FIG. 6 is a sequence diagram illustrating prior art.

FIG. 7a-e are is a sequence diagrams illustrating prior art.

FIG. 8 is a sequence diagram illustrating prior art.

FIG. 9 is a sequence diagram illustrating prior art.

FIG. 10 is a sequence diagram illustrating prior art.

FIG. 11 is a sequence diagram illustrating prior art.

FIG. 12 is a sequence diagram illustrating prior art.

FIG. 13 is a schematic block diagram illustrating prior art.

FIG. 14 is a schematic block diagram illustrating embodiments of a wireless communications network.

FIG. 15 is a flowchart depicting embodiments of a method in a network node.

FIG. 16 is a flowchart depicting embodiments of a method in a UE.

FIG. 17a-b are sequence diagrams depicting embodiments of a method in a wireless communications network.

FIG. 18 is a sequence diagram depicting embodiments of a method in a wireless communications network.

FIG. 19a-b are sequence diagrams depicting embodiments of a method in a wireless communications network.

FIG. 20 is a sequence diagram depicting embodiments of a method in a wireless communications network.

FIG. 21a-b are schematic block diagrams illustrating embodiments of a network node.

FIG. 22a-b are schematic block diagrams illustrating embodiments of a UE.

FIG. 23 schematically illustrates a telecommunication network connected via an intermediate network to a host computer.

FIG. 24 is a generalized block diagram of a host computer communicating via a base station with a user equipment over a partially wireless connection.

FIGS. 25-28 are flowcharts illustrating methods implemented in a communication system including a host computer, a base station and a user equipment.

### DETAILED DESCRIPTION

Example embodiments herein provide methods to enable MN-SN role switch during RRC Resume procedure, e.g. by reusing but swapping suspended also referred to as inactivated, MCG and SCG configurations for a new dual connectivity setup.

MN role: in MR-DC the network node also referred to as the radio access node that provides the control plane connection to the core network. It may be a Master eNB (in EN-DC), a Master ng-eNB (in NGEN-DC) or a Master gNB (in NR-DC and NE-DC). So the MN role would be a node acting as a master node.

SN role: in MR-DC, the radio access node, with no control plane connection to the core network, providing additional resources to the UE. It may be an en-gNB (in EN-DC), a Secondary ng-eNB (in NE-DC) or a Secondary gNB (in NR-DC and NGEN-DC).

An MCG (configuration): in MR-DC, a group of serving cells associated with the Master Node, comprising of the SpCell (Pcell) and optionally one or more SCells.

An SCG (configuration): in MR-DC, a group of serving cells associated with the Secondary Node, comprising of the SpCell (PSCell) and optionally one or more Scells.

An MCG cell may be associated to a radio node acting as an MN An SCG cell may be associated to a radio node acting as an SN.

Embodiments concern a method performed by a network node for handling a multi connectivity configuration for a UE resuming into connected mode from inactive mode in a wireless communications network comprising receiving a resume request from the UE, deciding whether or not to trigger a role switch of the first radio node and the second radio node for the multi connectivity configuration. Deciding to trigger the role switch may be based on a certain condition. The role switch may comprise switching the role of the first radio node from Master Node, MN, to Secondary Node, SN, and/or switching the role of the second radio node from SN to MN.

As discussed, the MN may be associated with a Master Cell Group, MCG, and the SN may be associated with a Secondary Cell Group, SCG. Accordingly, switching the role of the first radio node from MN to SN may correspond to switching the role of the MCG to SCG, and switching the role of the second radio node from SN to MN may correspond to switching the role of the SCG to MCG.

Another embodiment concerns a method performed by UE for handling a multi connectivity configuration when resuming into connected mode from inactive mode in a wireless communications network, the method comprising: sending a resume request message to a network node serving the UE, receiving an indication from the network node, which indication indicates a role switch of the radio first node and/or the second radio node in the multi connectivity configuration.

Similarly to the preceding embodiment, the role switch may comprise switching the role of the first radio node from MN to SN, and/or switching the role of the second radio node from SN to MN. Further similarly, the indication received by the UE may indicate a role switch of the MCG and/or SCG, e.g. form MCG to SCG, and from SCG to MCG.

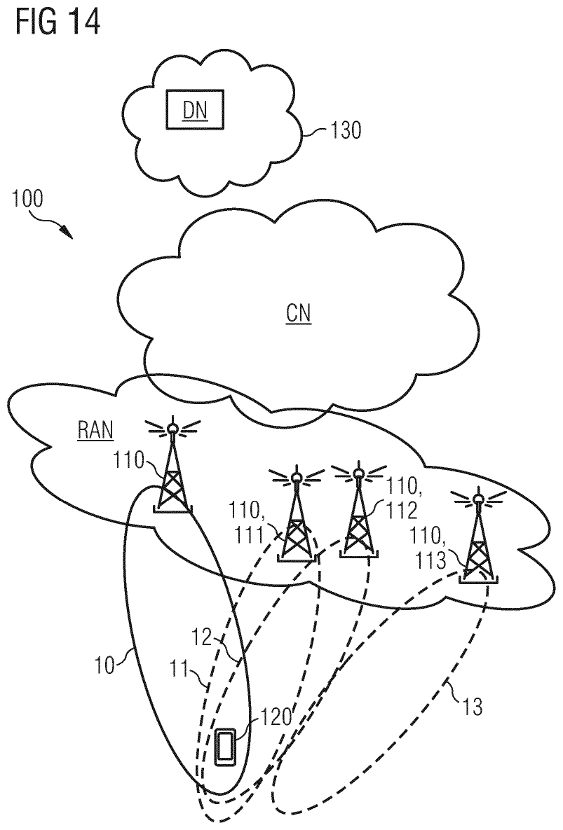

Embodiments herein relate to wireless communication networks in general. FIG. 14 is a schematic overview depicting a wireless communications network 100. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A plurality of network nodes operate in the wireless communications network 100 such as e.g. a network node 110, and a number of radio nodes such as e.g. a first radio node 111, a second radio node 112 and a third radio node 113. These nodes provide radio coverage in a number of cells which may also be referred to as a beam or a beam group of beams, such as a cell 10 provided by the network node 110, a cell 11 provided by the first radio node 111, a cell 12 provided by the second radio node 112, and a cell 13 provided by the third radio node 113. According to embodiments herein, the network node 110 may be a radio node and may be represented by any one out of: the first radio node 111, the second radio node 112 and the third radio node 113.

The respective network node 110, first radio node 111, second radio node 112 and third radio node 113 may e.g. be acting an MN role or an SN role, when serving a UE 120 in the wireless communications network 100, according to embodiments herein.

The network node 110, the first SN 111 and the second SN 112 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), ngNB, a base transceiver station, a radio remote unit, an Access Point Base Station, a base station router, a transmission arrangement of a radio base station, a stand-alone access point or any other network unit capable of communicating with a UE within the service area served by the respective network node 110 and radio node 111, 112, 113, depending e.g. on the first radio access technology and terminology used. The the respective network node 110 and radio node 111, 112, 113, may communicate with a UE 120 with Downlink (DL) transmissions to the UE 120 and Uplink (UL) transmissions from the UE 120.

In the wireless communication network 100, one or more UEs operate, such as e.g. the UE 120. The UE 120 may also referred to as a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

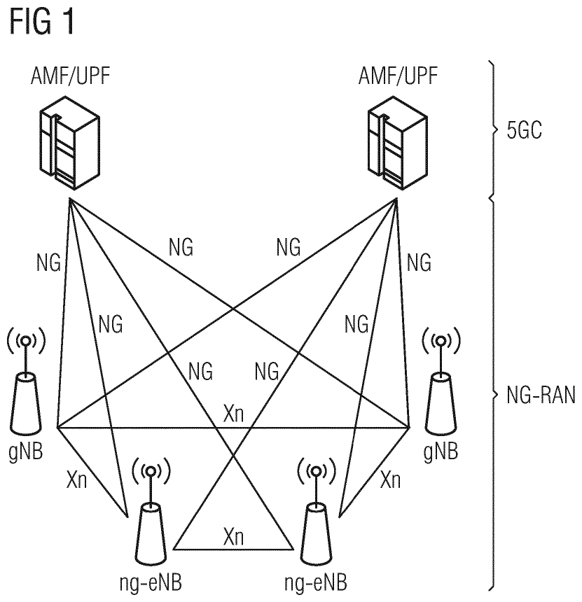

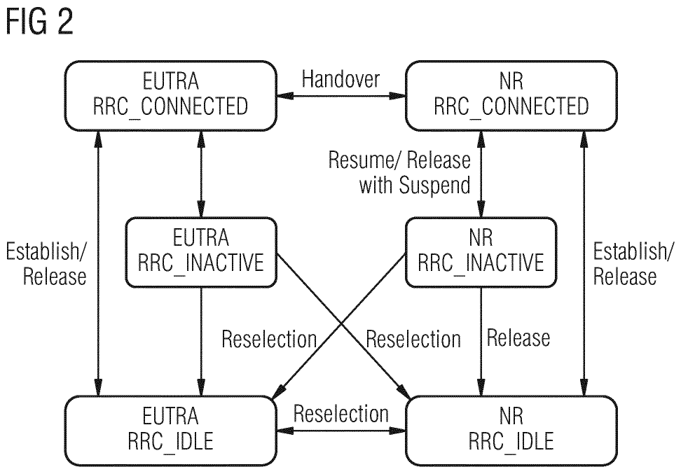

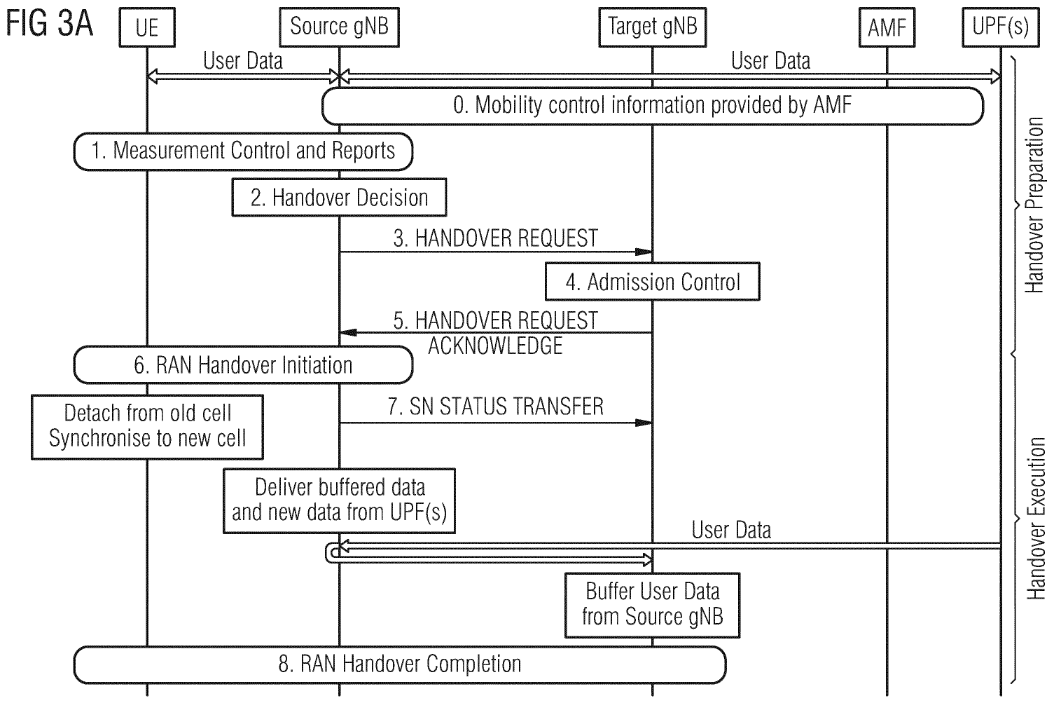

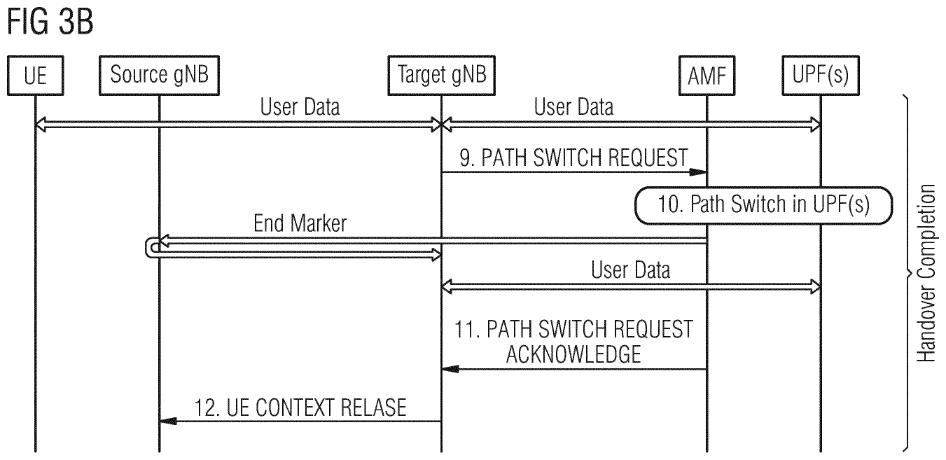

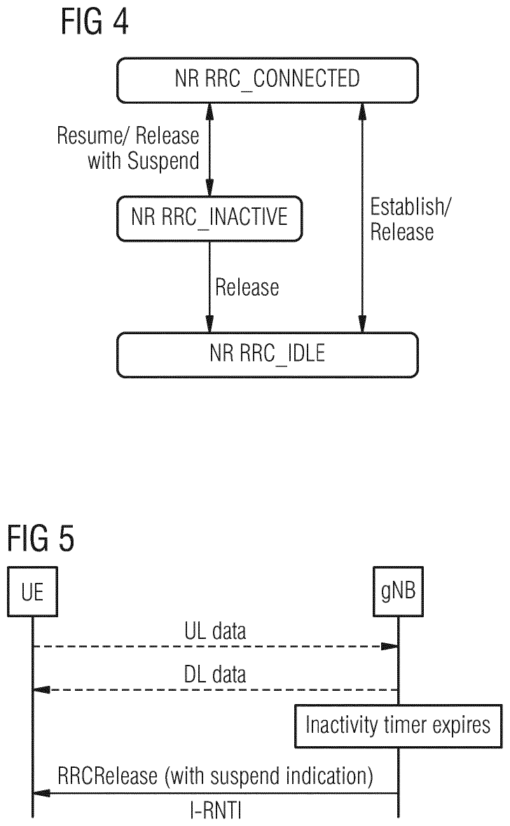

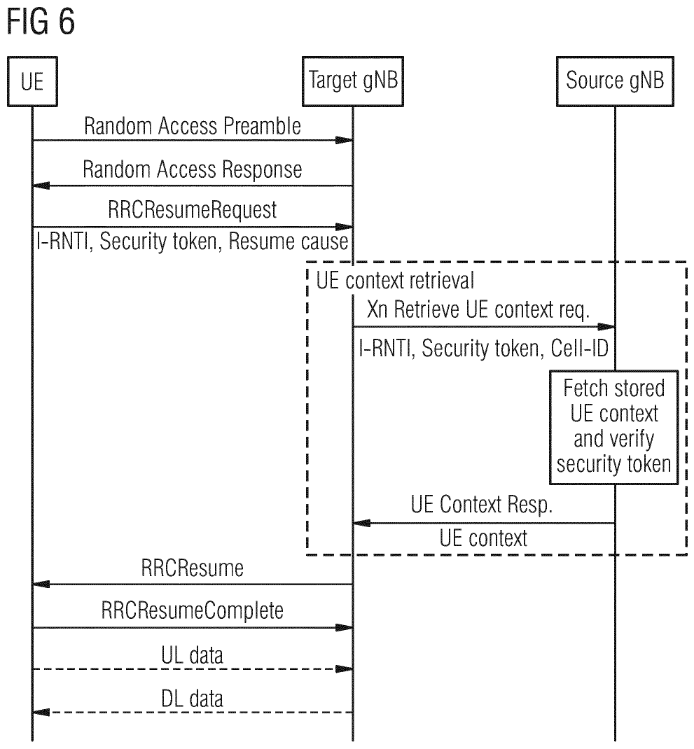

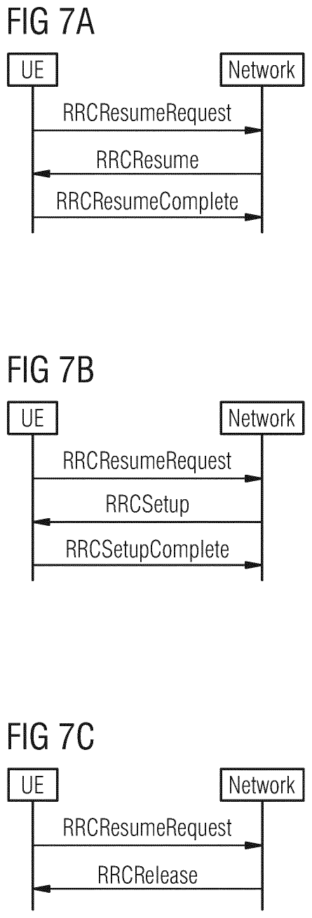

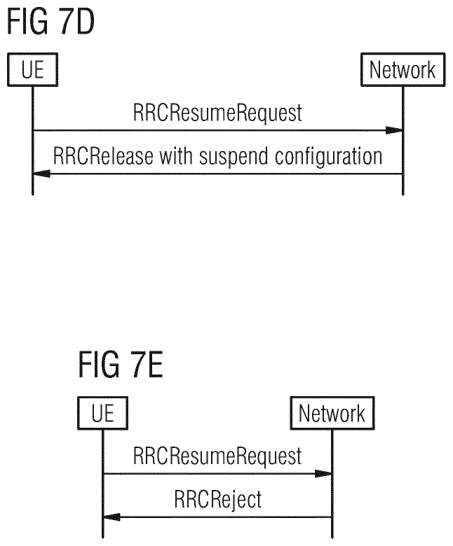

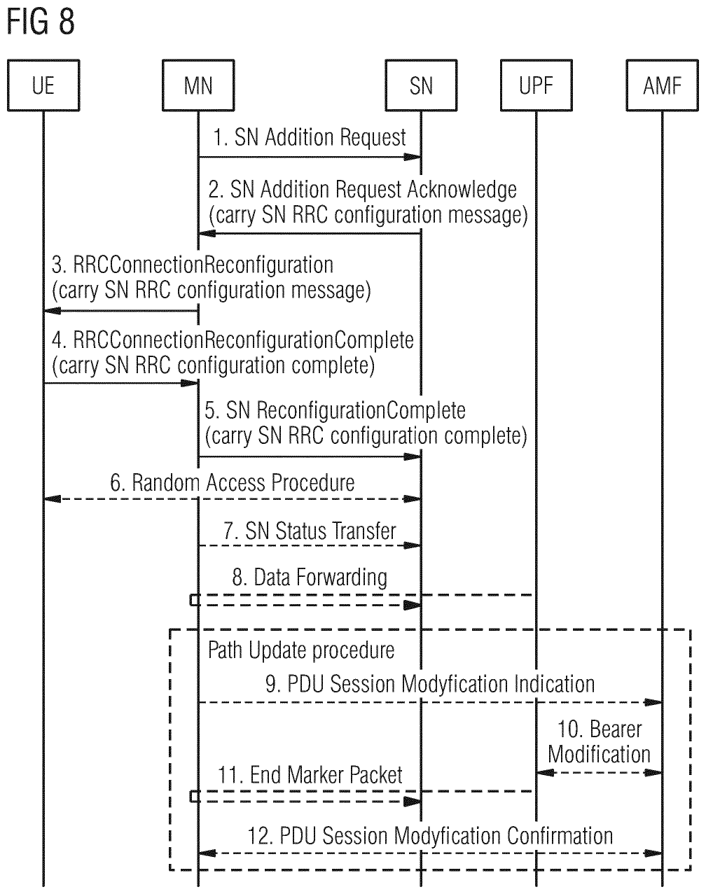

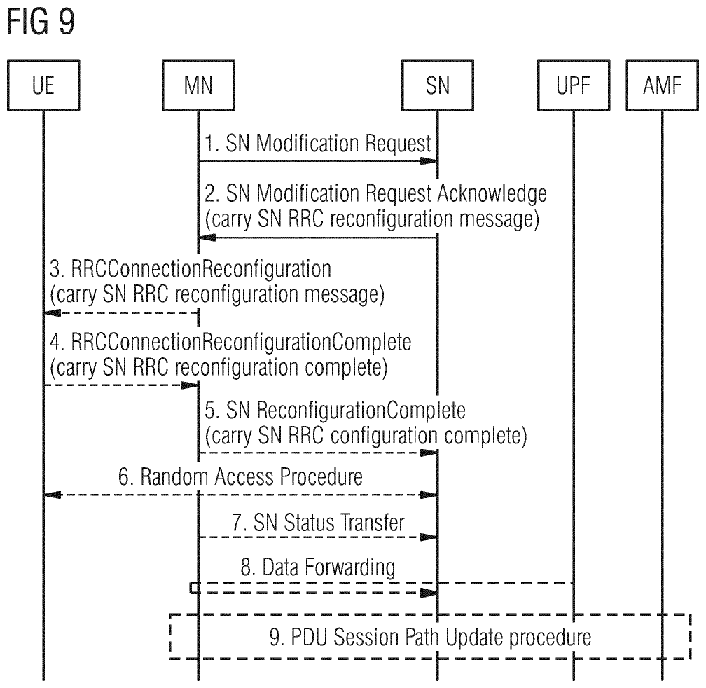

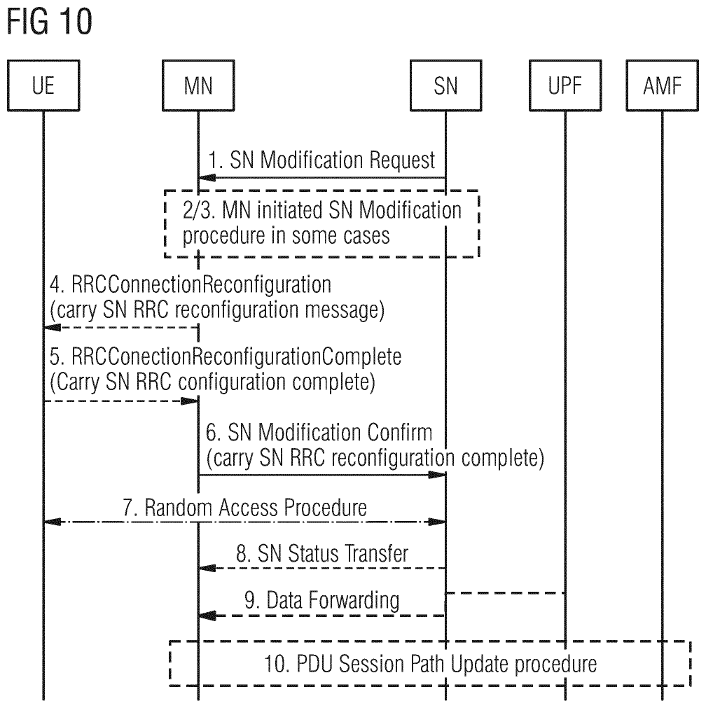

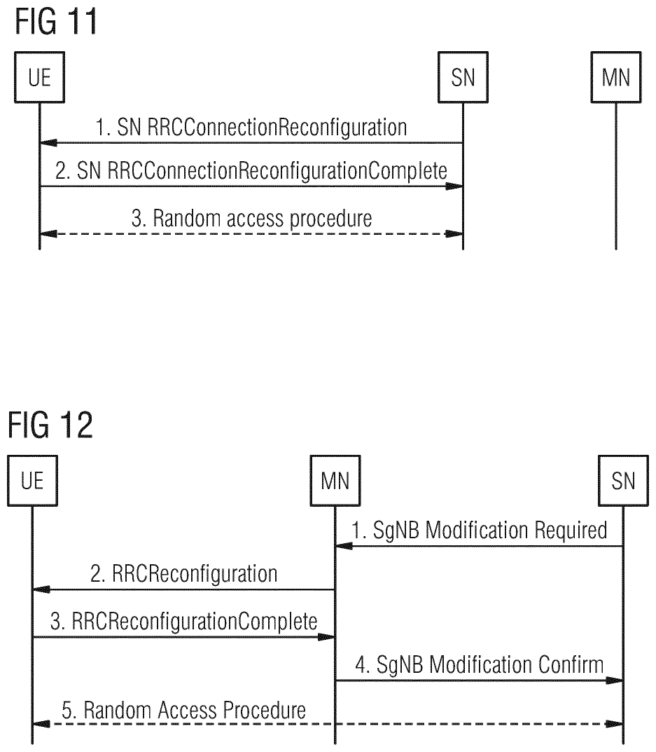

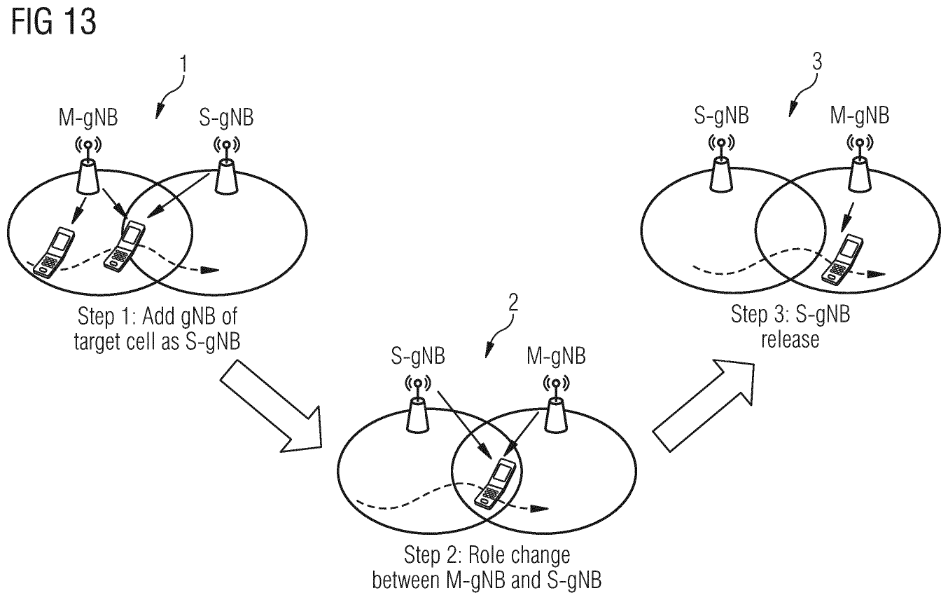

Methods herein may be performed by the network node 110. As an alternative, a Distributed Node (DN) and functionality, e.g. comprised in a cloud 130 as shown in FIG. 1, may be used for performing or partly performing the methods herein.

The above described problem is addressed in a number of embodiments, some of which may be seen as alternatives, while some may be used in combination.

As mentioned above, a set of embodiments is provided to enable role switch during a Resume procedure such as e.g. an RRC Resume procedure, by reusing but swapping the suspended MCG and SCG configurations for the new dual connectivity setup. The embodiments may comprise both UE 120 functionality to handle the role switch configurations as well as network node functionality, e.g. comprising signaling between network nodes and radio nodes, and to and/or from UEs such as the UE 120

With embodiments described herein, it will be possible to have the following advantages:
Minimized processing for generating RRC configurations.
Reduced inter-node signaling, leading to less network congestion and processing.
Reduced signaling between the MN and the UE, leading to less radio interface interference and power consumption.
Faster transition to DC, leading to lower latency experienced by end user such as the UE.
Different strategies enabled for inactive camping and connected DC, which may lead to optimizations in the UE power consumption and/or performance.

If no MN-SN role change is supported at Resume, then it may be either impossible or very inefficient to resume all the bearers when the UE is operating back in DC but with a role change.

In further examples of embodiments herein, depending on the situation there are different camping options in case of inactive state, which e.g. may comprise:
When the UE is in excellent coverage, the UE should use and/or camp on high band NR UL/DL.
When the UE is in good coverage, the UE should use and/or camp on low band NR, but use high band NR as DL boost.
When the UE is not in coverage of High band, the UE should use EN-DC.

In these scenarios it would be good to have an optimized role switch, e.g. the UE camps on low NR for fast access, and then quickly switches to high NR if good coverage of high NR, or stays if decent coverage using NR-NR DC, or switches to EN-DC if bad high NR coverage. Camping on the best layer may reduce power consumption as well as signalling since the UE does not need to perform registration area updates to the network so often.

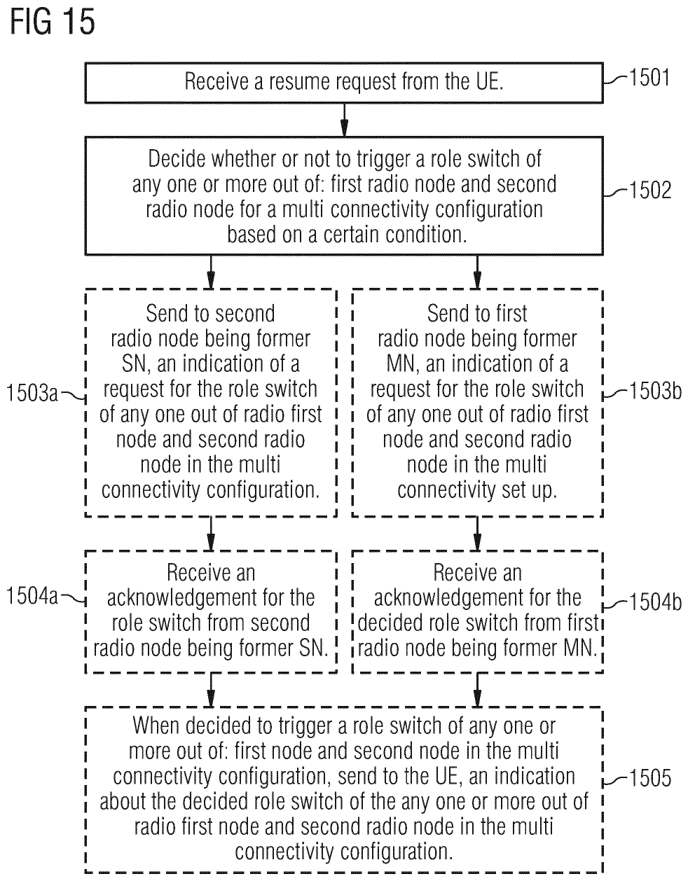

FIG. 15 shows example embodiments of a method performed by a network node 110 for handling a multi connectivity configuration for the UE 120 resuming into connected mode from inactive mode in a wireless communications network 100. The network node 110 may e.g. be represented by any one out of: The first radio node 111 being the former MN, the second radio node 112 being the former SN, or the third radio node 113.

Dashed boxes represent optional actions. The method comprises the following actions, which actions may be taken in any suitable order.

Action 1501

The UE 120 was multi connected to the first radio node 111 and the second radio node 112 before it entered into inactive mode. According to an example scenario, the UE 120 wishes to resume to a multi connectivity configuration again and therefore sends a resume request to the network node 110. The network node 110 thus receives a resume request from the UE 120.

Action 1502

According to the example scenario, if beneficial for the resumed multi connectivity, a role switch from MN to SN and/or from SN to MN of any of the first radio node 111 and the second radio node 112 shall be performed. The network node 110 decides whether or not to trigger a role switch of any one or more out of: The first radio node 111 and the second radio node 112. The role switch is for the multi connectivity configuration and is based on a certain condition. The role switch comprises any one out of:
Switching the role of the first radio node 111 from MN to SN and
switching the role of the second radio node 112 from SN to MN.

This means that in some embodiments the role switch comprises switching the role of the first radio node 111 from MN to SN. In some further embodiments, the role switch comprises switching the role of the second radio node 112 from SN to MN. In some further embodiments the role switch comprises switching the role of the first radio node 111 from MN to SN and switching the role of the second radio node 112 from SN to MN.

The MN may be associated with an MCG configuration, and the SN may be associated with a SCG configuration.

As mentioned above, an MCG means in MR-DC, a group of serving cells associated with the MN, comprising of the SpCell (Pcell) and optionally one or more Scells. This means that e.g. the gNB such as the first and second radio nodes 111, 112 has one or more cells. Each of these cells has specific cell identifiers.

The UE 120 may be configured with an MCG comprising one or more (or all) cells in the MN. One of these cells will be a special cell (SpCell). For the MCG this is called the primary cell PCell which the UE 120 will use as primary cell for communication. The other cells in the MCG are known as secondary cells (SCells) which are monitored, in case they become better and the UE 120 must handover.

The same thing goes for the SCG. The SN has a bunch of cells, and the UE 120 may be configured with an SCG comprising one or more (or all) of the SN's cells. One of the SCG cells will be a special cell also known as primary secondary cell PSCell similar to the PCell.

To switch the SCG configurations to become MCG configurations when performing a role switch e.g. means:

The UE 120 may have an IE called CellGroupConfig which comprises:
A cell group identity (cellGroupId)
Configurations for SpCell and all SCells

For the MCG, the cellGroupId=0, for SCG its=1.

E.g. in some embodiments when performing a role switch, instead of releasing the MCG and SCG configurations and sending all of them again, the UE 120 takes all configurations in the SCG and just changes the cellGroupId from 1 to 0.

In some embodiments the switching of the role of the first radio node 111 from MN to SN, comprises: The MCG configuration associated with the first radio node 111 becomes a basis for a new SCG configuration.

In some embodiments the switching of the role of the second radio node 112 from SN to MN comprises: The SCG configuration associated with the second radio node 112 becomes a basis for a new MCG configuration.

The certain condition may e.g. comprise any one or more out of:
Radio conditions between the UE 120 and any one or more out of the first node 111 and the second node 112,
radio conditions of any one out of the first node 111 and the second node 112,
a triggering of a Radio Access Network, RAN, paging due to a data associated with a former SN terminated bearer, requiring a quick resume of the connection to the former SN,
load conditions associated with any one out of the first node 111 and the second node 112, and
an indication of which radio node the UE 120 is resuming in.

In some embodiments, the network node 110 is represented by the first radio node 111 being the former MN. In these embodiments the Actions 1503a and 1504a may be performed.

Action 1503a

The network node 110 sends an indication to the second radio node 112 being the former SN. The indication indicates a request for the decided role switch of any one out of the radio first node 111 and the second radio node 112 in the multi connectivity configuration.

Action 1504a

The network node 110 receives an acknowledgement for the decided role switch from the second radio node 112 being the former SN.

In some embodiments, the network node 110 is represented by the second radio node 111 being the former SN. In these embodiments the Actions 1503b and 1504b may be performed.

Action 1503b

The network node 110 sends an indication to the first radio node 111 being the former MN. The indication indicates a request for the decided role switch of any one out of the radio first node 111 and the second radio node 112 in the multi connectivity set up.

Action 1504b

The network node 110 receives an acknowledgement for the decided role switch from the first radio node 111 being the former MN.

Action 1505

The network node 110 will then inform the UE 120 about the role switch. When decided to trigger a role switch of any one or more out of: the first node 111, and the second node 112 in the multi connectivity configuration, the network node 110 sends an indication to the UE 120. The indication is about the decided role switch of the any one or more out of: the radio first node 111 and the second radio node 112, in the multi connectivity configuration.

The indication about the decided role switch may comprise any one or more out of: The MCG, and the SCG, associated to the corresponding role of the any one or more out of: the first radio node 111 and the second radio node 112 in the multi connectivity according to the decided role switch.

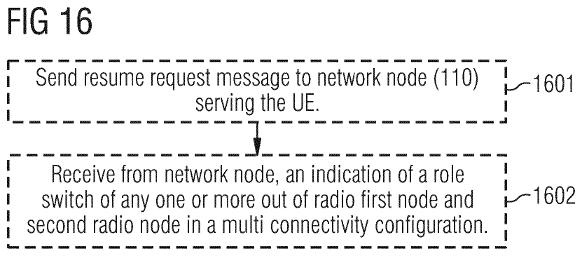

FIG. 16 show example embodiments of a method performed by the UE 120 for handling a multi connectivity configuration when resuming into connected mode from inactive mode in the wireless communications network 100. The UE 120 was multi connected to a first radio node 111 and the second radio node 112 before it entered into inactive mode.

Dashed boxes represent optional actions. The method comprises the following actions, which actions may be taken in any suitable order.

Action 1601

According to the example scenario, the UE 120 wishes to resume to a multi connectivity configuration again and therefore the UE 120 sends a resume request message to a network node 110 serving the UE 120.

Action 1602

The UE 120 receives an indication from the network node 110. The indication indicates a role switch of any one or more out of the radio first node 111 and the second radio node 112 in the multi connectivity configuration. The role switch comprises any one or more out of: switching the role of the first radio node 111 from MN to SN, and switching the role of the second radio node 112 from SN to MN. This means that in some embodiments the role switch comprises switching the role of the first radio node 111 from MN to SN. In some further embodiments, the role switch comprises switching the role of the second radio node 112 from SN to MN. In some further embodiments the role switch comprises switching the role of the first radio node 111 from MN to SN and switching the role of the second radio node 112 from SN to MN.

The MN may be associated with a MCG configuration, and the SN may be associated with a SCG configuration.

In some embodiments the switching of the role of the first radio node 111 from MN to SN, comprises: The MCG configuration associated with the first radio node 111 becomes a basis for a new SCG configuration.

In some embodiments the switching of the role of the second radio node 112 from SN to MN comprises: The SCG configuration associated with the second radio node 112 becomes a basis for a new MCG configuration.

The indication about the decided role switch may comprise any one or more out of: The MCG, and the SCG, associated to the corresponding role of the any one or more out of: the first radio node 111 and the second radio node 112 in the multi connectivity according to the decided role switch.

The above embodiments will now be further explained and exemplified below.

Herein, an example of NR dual connectivity is used, where both MN role and SN role are referred to as being acted by NR nodes. However, the embodiments are generally applicable to any two nodes operating under the same or different RAT, e.g. LTE-LTE DC, NR-NR DC,

EN-DC E-UTRA-NR Dual Connectivity,

NE-DC NR-E-UTRA Dual Connectivity,

NGEN-DC NG-RAN E-UTRA-NR Dual Connectivity,

NR-DC NR-NR Dual Connectivity,

LTE-LTE DC is only called DC (since this was the first version standardized).

Furthermore, all the embodiments are also applicable when there are more than two cell groups or nodes involved in the connectivity scenario i.e., multi-connectivity instead of dual connectivity.

Resumption in Former MN:

In one example of the embodiments, the UE 120 that was operating in DC mode is suspended, e.g. ordered to RRC_INACTIVE state. When it resumes later, e.g. due to pending UL message or data, or reception of a RAN paging indicating the arrival of a DL message, the UE 120 may send an RRC Resume Request to the former MN which is the first radio node 111 that was serving the UE 120 as the MN before the UE 120 went to inactive. The first radio node 111 in a role as former MN may then decide to trigger a role switch of the MN and SN, based on several factors such as e.g:
A reception of an early measurement from the UE 120, along with or immediately after the ResumeRequest message, that indicates that the secondary radio conditions of the second radio node 112 are better than the master radio conditions of the first network node 111. Resume Request is in LTE called RRCConnectionResumeRequest, and in NR it's called RRCResumeRequest.
A RAN paging was triggered due to a data associated with an SN terminated bearer of the second radio node 112, where it would be beneficial to quickly resume the connection to the second radio node 112 and switch it SN to MN role.
Or that load conditions has changed in the RAN since the UE 120 was last active, making it more optimal to serve the UE 120 in the second radio node 112 acting as SN and making the SN role be switched to the MN role. The first radio node 111 acting as the former MN then communicates with the second radio node 112 acting as the former SN to perform the role switching. In this role switch request, the first radio node being the former MN provides the configuration of the PDU session resources that are currently associated with the MN so that the second radio node 112 being the former SN can perform admission control and check if it can accommodate them. If the second radio node 112 being the former SN accepts the role switch request, the second radio node 112 being the former SN responds positively to the first radio node 111 being the former MN with a resume with role switch acknowledge.

The first radio node 111 being the former MN then sends an enhanced RRCResume message to the UE 120 that indicates the role-switch. The indication of the role switch may e.g. be done either implicitly or explicitly:

Implicitly: A full configuration flag is set, the former MCG configuration relating to the former MN is now indicated or reconfigured, as a new SCG configuration, e.g. cell group identity (ID) changed to 1, and former SCG configuration relating to the former SN is indicated or reconfigured, as the MCG configuration, e.g. cell group ID is set to 0.

Explicitly: A new Information element (IE) may be included, e.g. role-switch, the inclusion of which indicates to the UE 120 to perform the role-switch. The UE 120 will implicitly change the cell group ID of the former MCG to SCG, i.e. cell group ID set to 1 or some other value, and change the cell group ID of the former SCG to MSG, i.e. cell group id set to 0.

Whether explicit or implicit indications are used, old keys that were associated with the first radio node 111 being the former MN cannot typically be used in the second radio node 112 being new MN, as keys have to be changed when bearer termination is changed. Thus, a masterKeyUpdate may be introduced in the Resume message, like in the RRCReconfiguration message, and the sk-counter may also be included. The UE 120, using these two parameters will be able to derive the new master key and secondary key and also the encryption and/or integrity protection keys that are to be used for the bearers associated with the new master and secondary keys.
Alternatively, the UE 120 may perform a horizontal key derivation based on the knowledge, e.g. indication, that this is a Role Switch and in this way generate a fresh key which may be used for communication after the role switch.
Another alternative it is that the UE 120 would continue to use the new security keys which are generated during the resume procedure also for communication in the SN cell. On a high level this may violate the current security assumptions since the same keys would be used both in the first radio node 111 being the former MN node and in the second radio node 112 being the new MN. But this issue may be avoided on the network side by for instance by letting the second radio node 112 being the former SN encode the RRC Resume message and pass this message transparently to the UE 120 via the first radio node 111 being the former MN. In order to support this on the UE 120 side it is required that the UE 120 continue to use the keys even after the MN cell also referred to as the MCG cell, has changed.

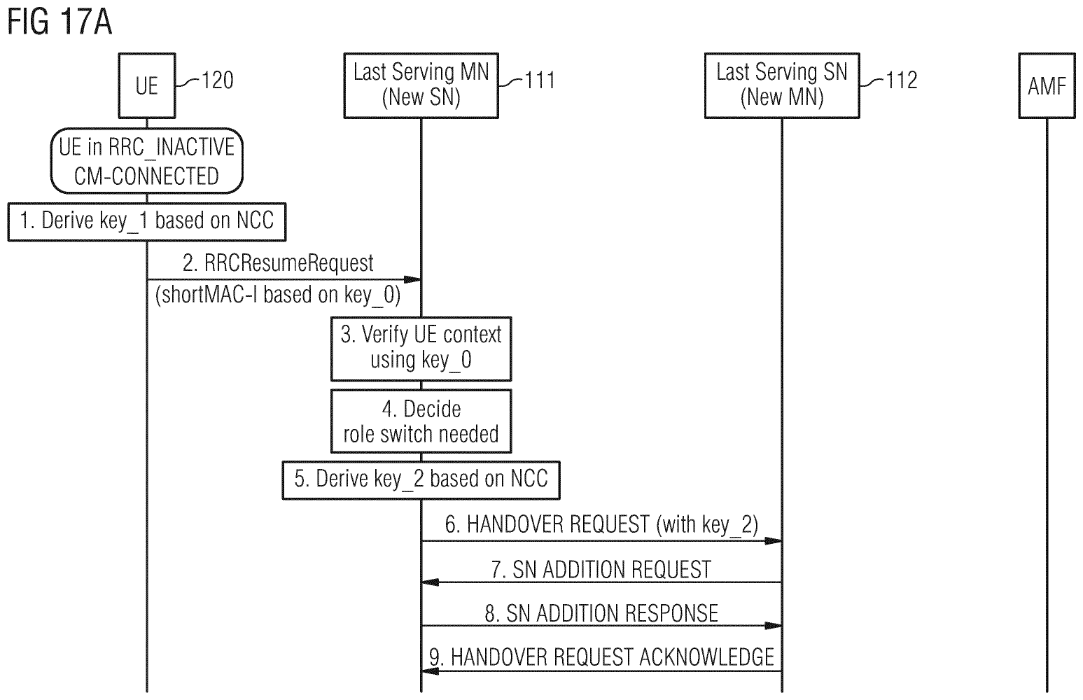

FIG. 17a depicts Actions 1-9, and FIG. 17b depicts Actions 10-16 of a Role-switch via former MN, key handling and signalling with CN according to embodiments herein.

Action 1. The UE 120 derives a new KgNB (key_1) based on the Next-Hop Chaining Count (NCC) it received in the RRCRelease message. A KgNB when used herein is a UE specific Access Stratum security key associated to the gNB used to derive encryption and integrity protection keys. The network node 110 is in this example represented by the first network node 111.

Action 2. The UE 120 transmits the RRCResumeRequest message to the first radio node 111 acting as former MN, containing a security token (shortMAC-I) which is calculated based on the former KgNB (key_0) which the UE 120 were using prior to suspension to RRC_INACTIVE.

Action 3. The first radio node 111 such as gNB, receiving the RRCResumeRequest verifies the UE 120 identity based on the received I-RNTI and the shortMAC-I.

Action 4. The first radio node 111 being the old MN, decides to trigger a role switch with the second radio node 112 being the old SN.

Action 5. The first radio node 111 being the old MN derives a new KgNB associated to the new MN, (i.e. the old SN) based on the next NCC. The next NCC when used herein means the incremented value of the NCC used in action 1.

NCC is just an integer pointing to a parameter in a list which both the UE 120 and network node 110 has or may create. The network node 110 only has to signal the index such as the the NCC of this parameter for the UE 120 to know which parameter it should use to derive the keys.

Action 6. The first radio node 111 being the old MN forwards the new key_2 e.g. by transmitting it in a handover request to the second radio node 112 being the old SN.

It should be noted that this message may be extended to include an indication for the role switch, or a new message is introduced to that effect.

Action 7. The second radio node 112 being the new MN transmits an SN addition request to the first radio node 111 being the old MN and the ew SN to reserve SN resources in the new SN.

Action 8. The first radio node 111 being the new SN responds with the configurations to be allocated.

Action 9. The second radio node 112 being the new MN responds to the first radio node 111 being the old MN with the handover request acknowledge which comprises the RRC message to be sent to the UE 120.

It should be noted that the messages in step 7-8 may be included in the messages 6 and 9 (if these messages are extended) to reduce the inter-node signalling.

Now referring to FIG. 17b.

Action 10. The first radio node 111 being the source MN transmits an extended RRCResume message to the UE 120. This message is protected using key_1, but comprises the NCC to calculate key_2 and an indication to perform the role switch.

Action 11. The UE 120 performs random access to the second radio node 112 being the old SN.

Action 12. The UE 120 transmits a message to the second radio node 112 being the new MN, e.g. a RRCResumeComplete message confirming the Resumption of the connection. This message is protected with the new key_2.

Action 13. The second radio node 112 being the new MN sends a message to the first radio node 111 being the new SN indicating that the role switch is completed.

Action 14. If necessary, the first radio node 111 being the source MN transmits a data forwarding address notification.

Action 15-16. The second radio node 112 being the new MN performs a path switch with the network.

On the CN side, the impact of the role-switch is that the termination of the bearers may have to be switched as well. This may be performed by a path update procedure that is currently used for SN addition/modification as mentioned above.

It should be noted that it is not required to change the bearer termination point just because the role is switched. In case there is no bearer termination change the RAN such as the network node 110 may still use the Path switch procedure to change the termination point of the CN/RAN signalling connection also referred to as the NG-AP connection.

As noted above, the signalling flow shows the case when the Resume message is generated by the first radio node 111 being the old MN node. It is also possible to generate the Resume message in the second radio node 112 being the new MN node and old SN. In this case the Resume message would be generated before step 9, encrypted and/or integrity protected by the PDCP layer in the second radio node 112 being the new MN and tunnelled transparently to the UE 120 in Step 9/10. The UE 120 does not need to be aware of that the message was generated by the second radio node 112 being the new MN. The first radio node 111 being the old MN would need to provide the second radio node 112 being the new MN with security key information corresponding to Key_1 so that the second radio node 112 being the new MN can encrypt the message. In this case it is not required to generate key_2 to be used for the RRC Resume Complete message, since new node is already using Key_1.

As an alternative embodiment of FIG. 17b, instead of sending one message in Action 10, the MN sends two messages, both the RRCResume and another message with the role Switch indication. However, these two messages are scheduled at the same time.

In some embodiments, the role switch is achieved by multiplexing an RRCResume message sent in response to an RRCResumeRequest like message to resume MN and SN suspended configuration(s) with an RRCReconfiguration message, possibly containing a reconfigurationWithSync or any other indication that MN/SN role switch shall be performed. The UE 120 may apply the RRCReconfiguration message after applying the RRCResume message. In one variant the UE 120 may apply the RRCReconfiguration before transmitting an RRCResumeComplete. This is possible in NR thanks to the fact that UE 120 has started security even before it receives an RRCResume message so that it may receive message encrypted and integrity protected on SRB1.

In a variant of the previous embodiment the RRCResume message comprises an indication that the SN configuration shall not be released so that the RRCReconfiguration that is multiplexed is used to trigger the role switch by relying on a restored SN configuration. For example, the UE 120 may restore the SN configuration, also referred to as SCG configuration upon the reception of RRCResume and, resume upon the reception of RRCReconfiguration.

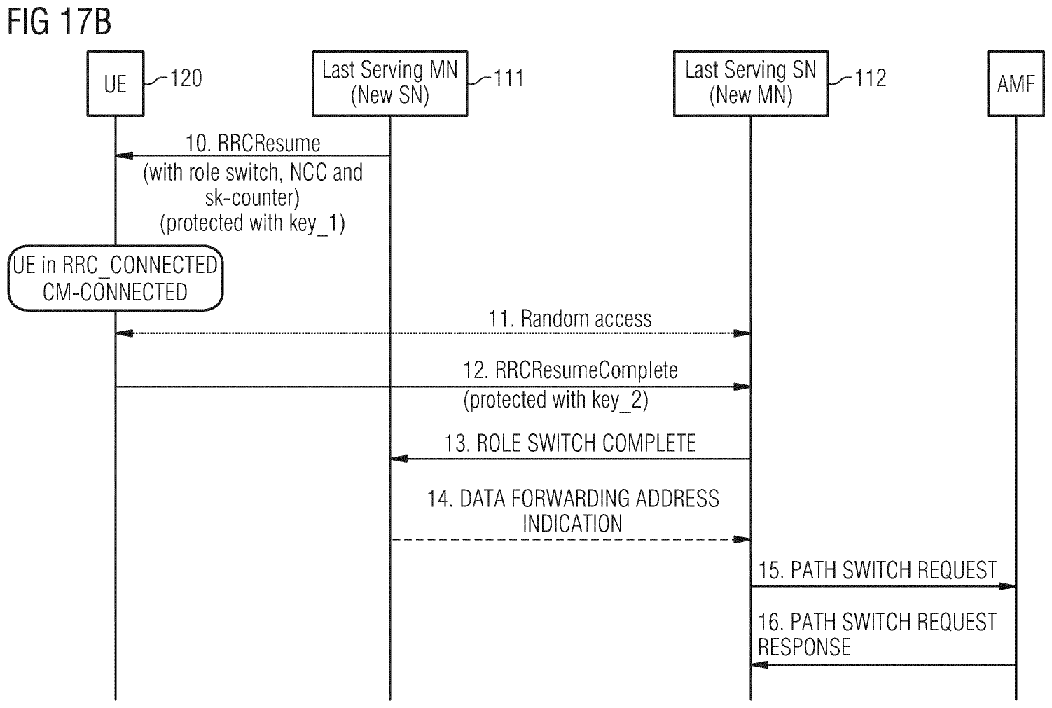

FIG. 18 depicts an embodiment wherein the UE 120 sends a RRC Resume Request to the first radio node 111 being the former MN.

The UE 120 sends (Action 1) a RRC Resume Request message to the first radio node 111 being the former MN.

The UE 120 further sends (Action 2) a scheduling request message to the first radio node 111.

The first radio node 111 sends (Action 3) a scheduling grant message to the UE 120.

The UE 120 further sends (Action 4) a measurement report message to the first radio node 111.

The first radio node 111 sends (Action 5) a resume with role-switch request message to the second radio node 112 being the former SN.

The second radio node 112 sends (Action 6) a resume with role switch acknowledge (ACK) message to the first radio node 111.

The first radio node 111 sends (Action 7) a resume with role switch message to the UE 120.

The UE 120 performs (Action 8) random access to the second radio node 112 being the new MN.

The UE 120 sends (Action 9) a resume complete message to the first radio node 111.

Resumption in Former SN:

In some of the embodiments, a UE 120 that was operating a multi connectivity mode that in this example is a DC mode, is suspended and when it resumes later e.g. due to a pending UL message or reception of a RAN paging indicating an arrival of a DL message, the UE 120 sends an RRC Resume Request to the node that was serving the UE 120 as the SN before the UE 120 went to inactive, e.g. the second radio node 112. This may be, for example, that a cell belonging to the second radio node 112 being the former SN is the best cell for the UE 120 e.g., from radio conditions perspective. In these embodiments the network node 110 is represented by the second radio node 112. The second radio node 112 being the former SN may then decide to trigger role switch of the master and secondary, e.g., based on network/UE measurements, network load, QoS/service etc.

The second radio node 112 being the former SN then communicates with the first radio node 111 being the former MN to perform the role switching. The first radio node 111 being the former MN provides to the second radio node 112 being the new MN, the configuration of the PDU session resources that are currently associated with the MN so that the second radio node 112 being the new MN can perform admission control and check if it can accommodate them. If so, i.e. second radio node 112 being the new MN has the required resources, the second radio node 112 being the new MN responds positively with a resume with role switch acknowledge.

As an alternative to the above procedure it is also possible for the first radio node 111 being the former MN to determine that a role switch should be performed. In this case the second radio node 112 being the former SN node who receive the Resume Request will send a message to the first radio node 111 being the former MN, e.g. UE context request message. Further, in response to the message, the first radio node 111 being the former MN may indicate to the second radio node 112 being the former SN that a role switch procedure should be performed.

The second radio node 112 being the former SN then sends an enhanced RRCResume message to the UE 120 that indicates the role-switch. The indication of the role switch may be done either implicitly or explicitly:
Implicitly: The full configuration flag may be set, the former MCG configuration is now indicated as a SCG configuration, e.g. cell group id changed to 1, and former SCG configuration is indicated as the MCG configuration, e.g. cell group id set to 0.
Explicitly: A new IE is included, e.g. role-switch, the inclusion of which indicates to the UE 120 to perform the role-switch. The UE 120 may implicitly change the cell group ID of the former MCG to SCG, i.e. cell group id set to 1 or some other value, and change the cell group ID of the former SCG to MCG, i.e. cell group id set to 0.

Whether explicit or implicit indications are used, since in this case the second radio node 112 being the new MN node and old SN, is generating the resume message there may be no need to updated the security key of the UE 120 after the Resume message since the key used to protect the Resume message is already a fresh key which the UE 120 generates during the Resume, corresponding to key_1 in the previous section and below.

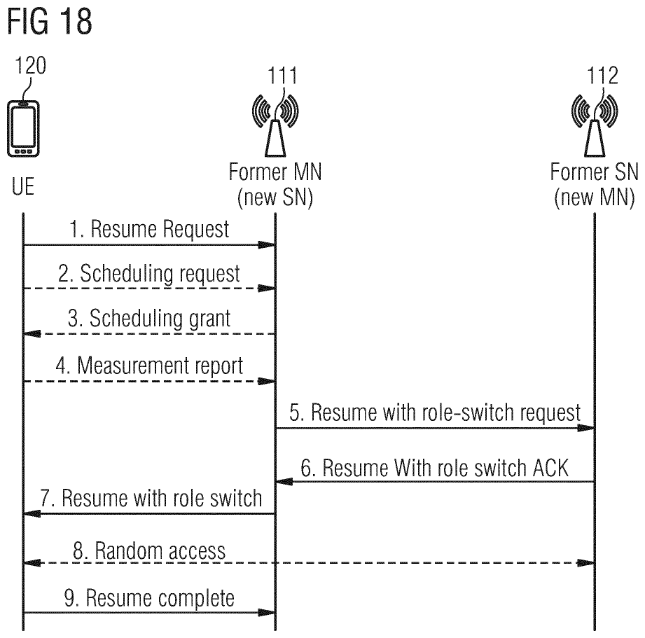

FIG. 19a depicts Actions 1-6 and FIG. 19b depicts Actions 7-14 of a Role-switch via former SN, key handling and signalling with CN. The network node 110 is in this example represented by the second radio node 112.

The UE 120 derives a key_1 based on NCC (Action 1).

The UE 120 sends (Action 2) an RRCResumeRequest comprising shortMAC-I with key_0 to the second radio node 112 being the last serving SN and new MN.

The second radio node 112 recognises UE I-RNTI and decides that a role switch is needed, and thus triggers a role switch”, and sends (Action 3) RETRIEVE UE CONTEXT REQUEST message with a role switch indication to the first radio node 111 being the last serving MN and the new SN.

The first radio node 111 allocates (Action 4) resources as an SN.

The first radio node 111 being the new SN verifies (Action 5) the UE Context using key_0.

The first radio node 111 being the new SN sends (Action 6) a RETRIEVE UE CONTEXT RESPONSE message with a role switch acknowledge to the second radio node 112 being the new MN.

The second radio node 112 calculates (Action 7) key_1 based on NCC and sends (Action 8) an RRCResume protected with key_1.

The UE 120 enters in RRC_CONNECTED CM-CONNECTED mode, and sends (Action 9) a RRCResumeComplete message to the second radio node 112 being the new MN.

The UE 120 performs (Action 10) random access to the first radio node 111 being the new SN.

The second radio node 112 being the new MN sends (Action 11) a ROLE SWITCH COMPLETE message to the first radio node 111 being the new SN.

The second radio node 112 further sends (Action 12) a DATA FORWARDING ADDRESS INDICATION message to the first radio node 111.

The second radio node 112 further sends (Action 13) a PATH SWITCH REQUEST message to an AMF node in the communications network 100.

The AMF node sends (Action 14) a PATH SWITCH RESPONSE message to the second radio node 112 being the new MN.

CM-CONNECTED when used herein means Connection Management (CM)-CONNECTED. A UE in CM-CONNECTED state has a NAS signalling connection with the AMF over N1. A NAS signalling connection uses an RRC Connection between the UE and the NG-RAN and an NGAP UE association between the Access Network (AN) and the AMF for 3GPP access. A UE may be in CM-CONNECTED state with an NGAP UE association that is not bound to any Transport Network Layer Association (TNLA) between the AN and the AMF. Upon completion of a NAS signalling procedure, the AMF may decide to release the NAS signalling connection with the UE.

On the CN side, the impact of the role-switch is that the termination of the bearers may have to be switched as well. This may be performed by a path update procedure that is currently used for SN addition/modification as mentioned above.

It should be noted that it is not required to change the bearer termination point just because the role is switched. In case there is no bearer termination change the RAN can still use the Path switch procedure to change the termination point of the CN/RAN signalling connection such as NG-AP connection.

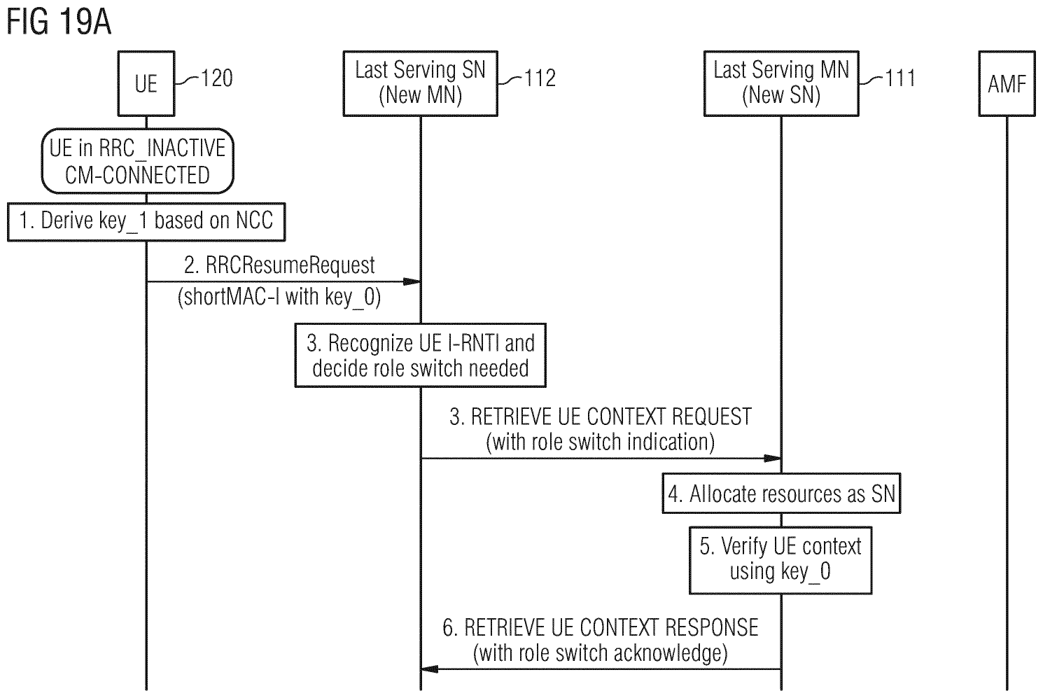

FIG. 20 depicts some embodiments wherein the UE 120 sends an RRC Resume Request to former SN.

The UE 120 sends (Action 1) a RRC Resume Request to the second radio node 112 being the former SN.

The UE 120 further sends (Action 2) a scheduling request to the second radio node 112.

The second radio node 112 sends (Action 3) a scheduling grant to the UE 120.

The UE 120 further sends (Action 4) a measurement report to the second radio node 112.

The second radio node 112 sends (Action 5) a resume message with role switch indication to the first radio node 111 being the former MN.

The first radio node 111 sends (Action 6) a resource required message to the second radio node 112.

The second radio node 112 sends (Action 7) a resume message with role switch acknowledge (ACK) message to the first radio node 111 being the former MN.

The second radio node 112 sends (Action 8) a resume message with role change message to the UE 120.

The UE 120 performs (Action 9) random access to the first radio node 111 being the new SN.

UE Requested Role Switch Upon RRC Resume

In some other embodiments, the UE 120 indicates in the RRCResumeRequest that it has good coverage towards the first radio node 111 being the old MN and the second radio node 112 being the old SN based on recent measurements.

This indication may e.g. be a new resume cause, as there are a few spare values as seen below:

ResumeCause

The IE ResumeCause is used to indicate the resume cause in RRCResumeRequest and RRCResumeRequest1.

ResumeCause Information Element

| -- ASN1START | |
|---|---|
| -- TAG-RESUME-CAUSE-START | |
| ResumeCause ::= | ENUMERATED {emergency, |

highPriorityAccess, mt-Access, mo-Signalling,

mo-Data, mo-

VoiceCall, mo-VideoCall, mo-SMS, rna-Update, mps-
PriorityAccess, mcs-PriorityAccess,
spare1, spare2, spare3, spare4, spare5 }
-- TAG-RESUME-CAUSE-STOP
-- ASN1STOP

Or the spare value in the RRCResumeRequest message may be used:

RRCResumeRequest Message

| -- ASN1START | |
|---|---|
| -- TAG-RRCRESUMEREQUEST-START | |
| RRCResumeRequest ::= | SEQUENCE { |
| rrcResumeRequest | RRCResumeRequest-IEs |
| } | |
| RRCResumeRequest-IEs ::= | SEQUENCE { |
| resumeIdentity | ShortI-RNTI-Value, |
| resumeMAC-I | BIT STRING (SIZE (16)), |
| resumeCause | ResumeCause, |
| spare | BIT STRING (SIZE (1)) |

}
-- TAG-RRCRESUMEREQUEST-STOP
-- ASN1STOP

Alternatively, a new message may be introduced using the same or a different logical channel.

The UE 120 may include this indication when transmitting the RRCResumeRequest to the first radio node 111 being the old MN or the second radio node 112 being the old SN to indicate that it would be suitable to perform a role switch at resume.

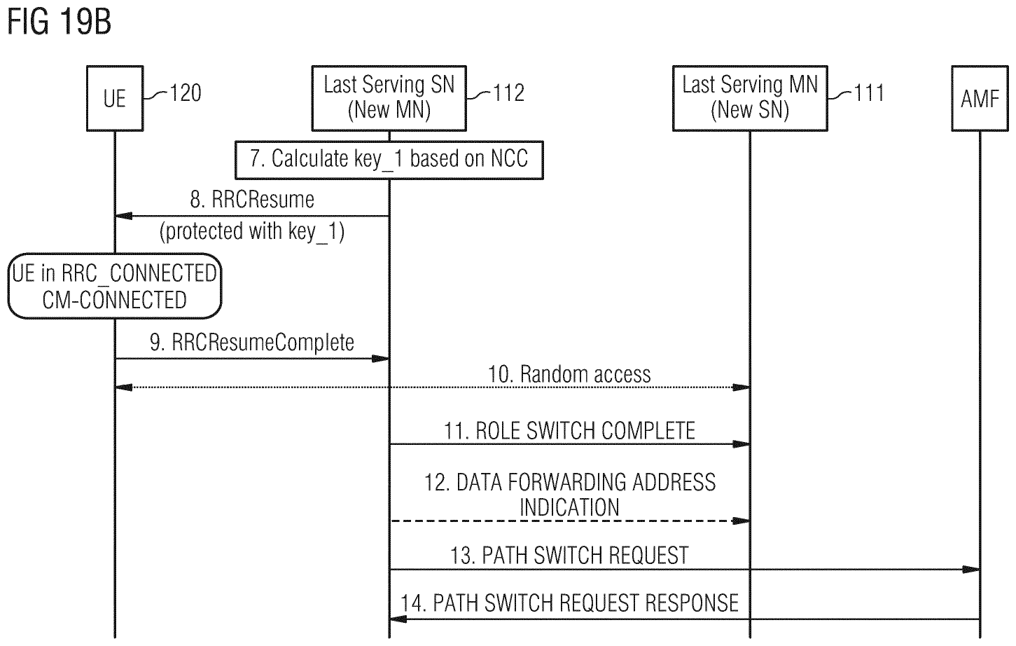

To perform the method actions above, the network node 110 configured to handle a multi connectivity configuration for the UE 120 adapted to resume into connected mode from inactive mode in a wireless communications network 100, may comprise an arrangement depicted in FIGS. 21a and 21b. The UE 120 is adapted to be multi connected to a first radio node 111 and a second radio node 112 before it entered into inactive mode. 24. The network node 110 may e.g. be adapted to be represented by any one out of: The first radio node 111 being the former MN, the second radio node 112 being the former SN, or the third radio node 113.

The network node 110 may comprise an input and output interface 2100 configured to communicate with UEs such as the UE 120. The input and output interface 2100 may comprise a wireless receiver (not shown) and a wireless transmitter (not shown).

The network node 110 is further configured to, e.g. by means of a receiving unit 2110 in the network node 110, receive a resume request from the UE 120.

The network node 110 is further configured to, e.g. by means of a deciding unit 2120 in the network node 110, decide whether or not to trigger a role switch of any one or more out of: the first radio node 111 and the second radio node 112 for the multi connectivity configuration based on a certain condition. The role switch is adapted to comprise any one out of:
switch the role of the first radio node 111 from Master Node, MN, to Secondary Node, SN, and
switch the role of the second radio node 112 from SN to MN.

The MN may be adapted to be associated with an MCG configuration, and the SN may be adapted to be associated with an SCG configuration.

The switch the role of the first radio node 111 from MN to SN, may comprise: the MCG configuration adapted to be associated with the first radio node 111 becomes a basis for a new SCG configuration and the switch the role of the second radio node 112 from SN to MN may comprise: the SCG configuration adapted to be associated with the second radio node 112 becomes a basis for a new MCG configuration.

The certain condition may be adapted to comprise any one or more out of:
Radio conditions between the UE 120 and any one or more out of the first node 111 and the second node 112,
radio conditions of any one out of the first node 111 and the second node 112,
a triggering of a Radio Access Network, RAN, paging due to a data associated with a former SN terminated bearer, requiring a quick resume of the connection to the former SN,
load conditions associated with any one out of the first node 111 and the second node 112,
an indication of which radio node the UE 120 is resuming in.

The network node 110 may further be configured to, e.g. by means of a sending unit 2130 in the network node 110, when decided to trigger a role switch of any one or more out of: the first node 111, and the second node 112 in the multi connectivity configuration, send to the UE 120, an indication about the decided role switch of the any one or more out of the radio first node 111 and the second radio node 112 in the multi connectivity configuration.

The indication about the decided role switch may be adapted to comprise any one or more out of: the MCG and the SCG, associated to the corresponding role of the any one or more out of: the first radio node 111 and the second radio node 112 in the multi connectivity according to the decided role switch.

In some embodiments, the network node 110 is adapted to be represented by the first radio node 111 being the former MN.

In these embodiments, the network node 110 may further be configured to, e.g. by means of the sending unit 2130 in the network node 110, send an indication to the second radio node 112 being the former SN, which indication indicates a request for the decided role switch of any one out of the radio first node 111 and the second radio node 112 in the multi connectivity configuration.

In these embodiments, the network node 110 may further be configured to, e.g. by means of the receiving unit 2110 in the network node 110, receive an acknowledgement for the decided role switch from the second radio node 112 being the former SN.

In some embodiments, the network node 110 is adapted to be represented by the second radio node 111 being the former SN

In these embodiments, the network node 110 may further be configured to, e.g. by means of the sending unit 2130 in the network node 110, send an indication to the first radio node 111 being the former MN, which indication indicates a request for the decided role switch of any one out of the radio first node 111 and the second radio node 112 in the multi connectivity set up.

In these embodiments, the network node 110 may further be configured to, e.g. by means of the receiving unit 2110 in the network node 110, receive an acknowledgement for the decided role switch from the first radio node 111 being the former MN.

The embodiments herein may be implemented through a processor or one or more processors, such as the processor 2140 of a processing circuitry in the the network node 110 depicted in FIG. 21a, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 2150 comprising one or more memory units. The memory 2150 comprises instructions executable by the processor in network node 110. The memory 2150 is arranged to be used to store e.g. information, indications, keys, data, configurations, and applications to perform the methods herein when being executed in the network node 110.

In some embodiments, a computer program 2160 comprises instructions, which when executed by the respective at least one processor 2140, cause the at least one processor 2140 of the network node 110 to perform the actions above.

In some embodiments, a carrier 2170 comprises the respective computer program 560, wherein the carrier is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110, that when executed by the respective one or more processors such as the processor described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

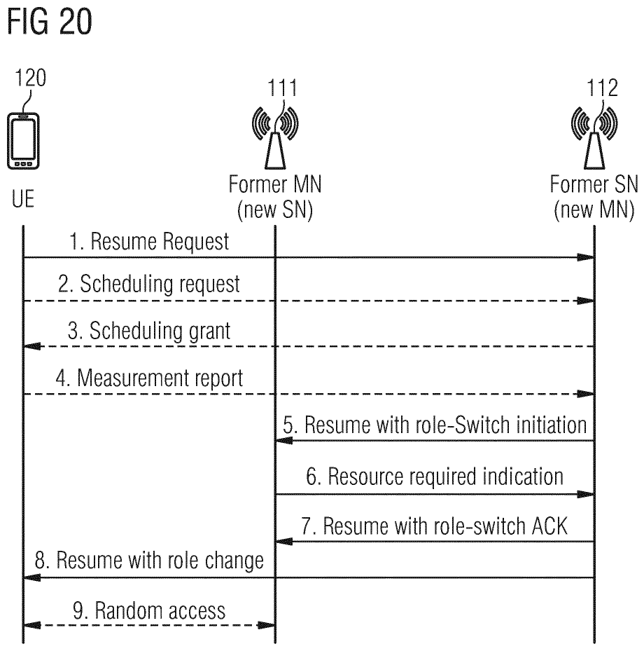

To perform the method actions above, the UE 120 configured to handle a multi connectivity configuration to resume into connected mode from inactive mode in a wireless communications network 100 may comprise an arrangement depicted in FIGS. 22a and 22b. The UE 120 is adapted to have been multi connected to a first radio node 111 and a second radio node 112 before it enters into inactive mode.

The UE 120 may comprise an input and output interface 2200 configured to communicate with network nodes such as the network node 110, the first radio node 111, the second radio node 112 and the third radio node 113. The input and output interface 2200 may comprise a wireless receiver (not shown) and a wireless transmitter (not shown).

The UE 120 may further be configured to, e.g. by means of a sending unit 2210 in the UE 120, send a resume request message to a network node 110 serving the UE 120.

The UE 120 may further be configured to, e.g. by means of a receiving unit 2220 in the UE 120, receive an indication from the network node 110, which indication indicates a role switch of any one or more out of the radio first node 111 and the second radio node 112 in the multi connectivity configuration, wherein the role switch is adapted to comprise any one or more out of: Switching the role of the first radio node 111 from MN to SN and switching the role of the second radio node 112 from SN to MN.

The MN may be adapted to be associated with a MCG configuration, and the SN may be adapted to be associated with a SCG configuration.

The switching of the role of the first radio node 111 from MN to SN, may be adapted to comprise: the MCG configuration associated with the first radio node 111 becomes a basis for a new SCG configuration.

The switching of the role of the second radio node 112 from SN to MN may be adapted to comprise: the SCG configuration associated with the second radio node 112 becomes a basis for a new MCG configuration.

The indication about the role switch may be adapted to comprise any one or more out of: the MCG, and the SCG, associated to the corresponding role being switched to of the any one or more out of: the first radio node 111 and the second radio node 112 in the multi connectivity according to the decided role switch.

The embodiments herein may be implemented through a processor or one or more processors, such as the processor 2230 of a processing circuitry in the the UE 120 depicted in FIG. 22a, together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise a memory 2240 comprising one or more memory units. The memory 2240 comprises instructions executable by the processor in the UE 120. The memory 2240 is arranged to be used to store e.g. information, indications, data, configurations, and applications to perform the methods herein when being executed in the UE 120.

In some embodiments, a computer program 2250 comprises instructions, which when executed by the respective at least one processor 2230, cause the at least one processor 2230 of the UE 120 to perform the actions above.

In some embodiments, a carrier 2260 comprises the respective computer program 2250, wherein the carrier 2260 is one of an electronic signal, an optical signal, an electromagnetic signal, a magnetic signal, an electric signal, a radio signal, a microwave signal, or a computer-readable storage medium.

Those skilled in the art will appreciate that the units in the UE 120 described above may refer to a combination of analog and digital circuits, and/or one or more processors configured with software and/or firmware, e.g. stored in the UE 120, that when executed by the respective one or more processors such as the processor described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

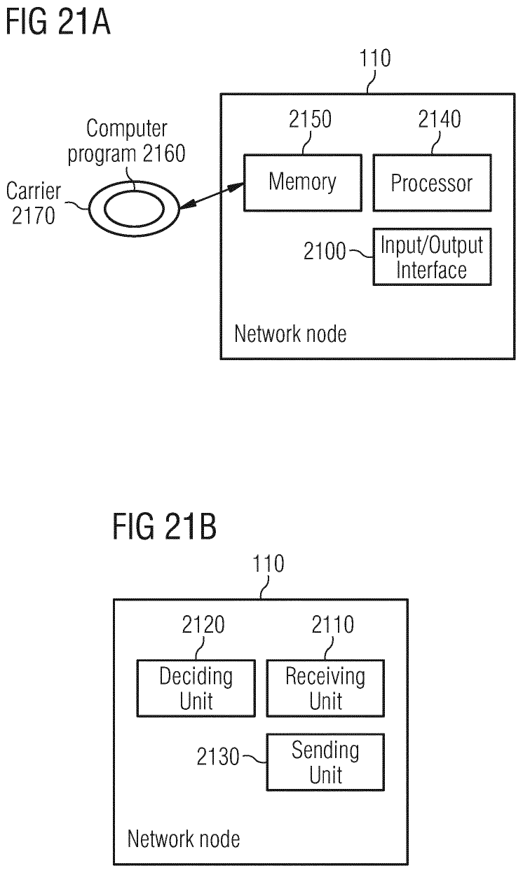

With reference to FIG. 23, in accordance with an embodiment, a communication system includes a telecommunication network 3210, such as a 3GPP-type cellular network, which comprises an access network 3211, such as a radio access network, and a core network 3214. The access network 3211 comprises a plurality of base stations, 3212a, 3212b, 3212c, e.g. the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 19 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

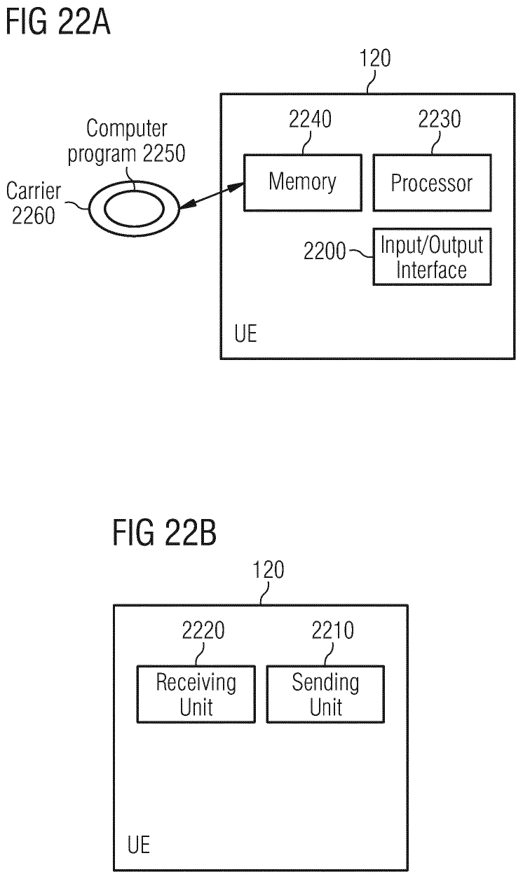

Example implementations, in accordance with an embodiment, of the UE, base station and host computer discussed in the preceding paragraphs will now be described with reference to FIG. 24. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 24) served by the base station 3320. The communication interface 3326 may be configured to facilitate a connection 3360 to the host computer 3310. The connection 3360 may be direct or it may pass through a core network (not shown in FIG. 24) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 24 may be identical to the host computer 3230, one of the base stations 3212a, 3212b, 3212c and one of the UEs 3291, 3292 of FIG. 19, respectively. This is to say, the inner workings of these entities may be as shown in FIG. 24 and independently, the surrounding network topology may be that of FIG. 19.

In FIG. 24, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

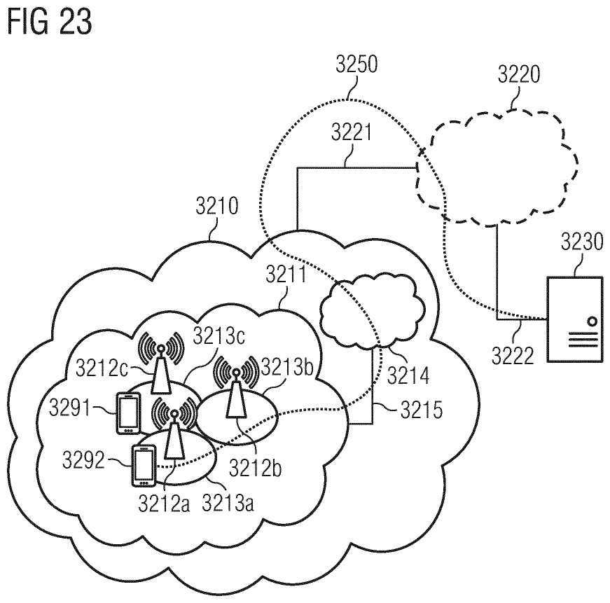

FIG. 25 is a flowchart illustrating a method implemented in a communication system, in accordance with one embodiment. The communication system includes a host computer, a base station such as a AP STA, and a UE such as a Non-AP STA which may be those described with reference to FIG. 19 and FIG. 24. For simplicity of the present disclosure, only drawing references to FIG. 25 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

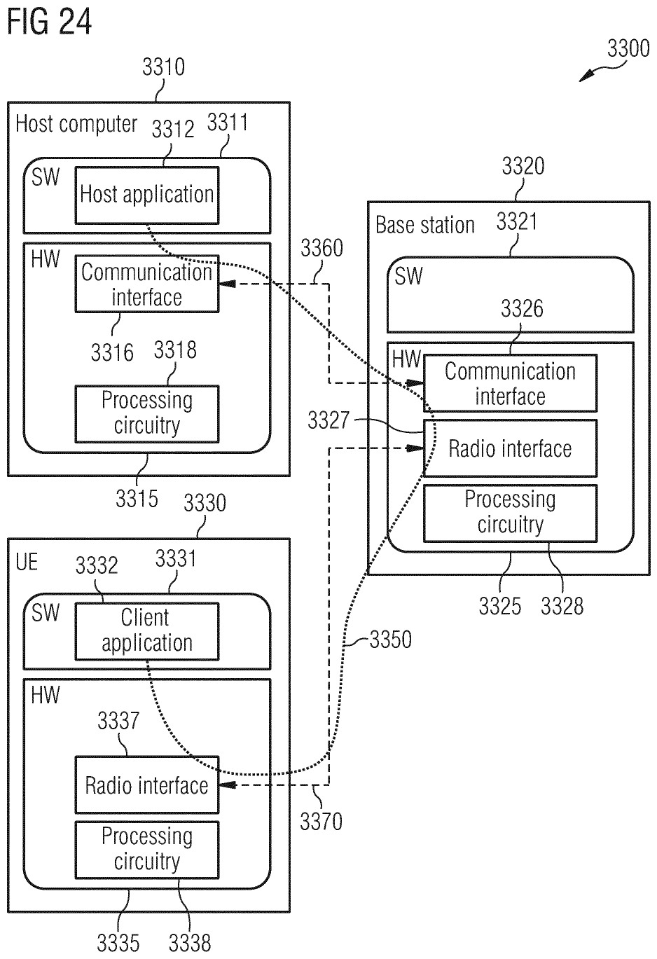

FIG. 26 is a flowchart illustrating a method implemented in a communication system, in accordance with one embodiment. The communication system includes a host computer, a base station such as a AP STA, and a UE such as a Non-AP STA which may be those described with reference to FIG. 19 and FIG. 24. For simplicity of the present disclosure, only drawing references to FIG. 26 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

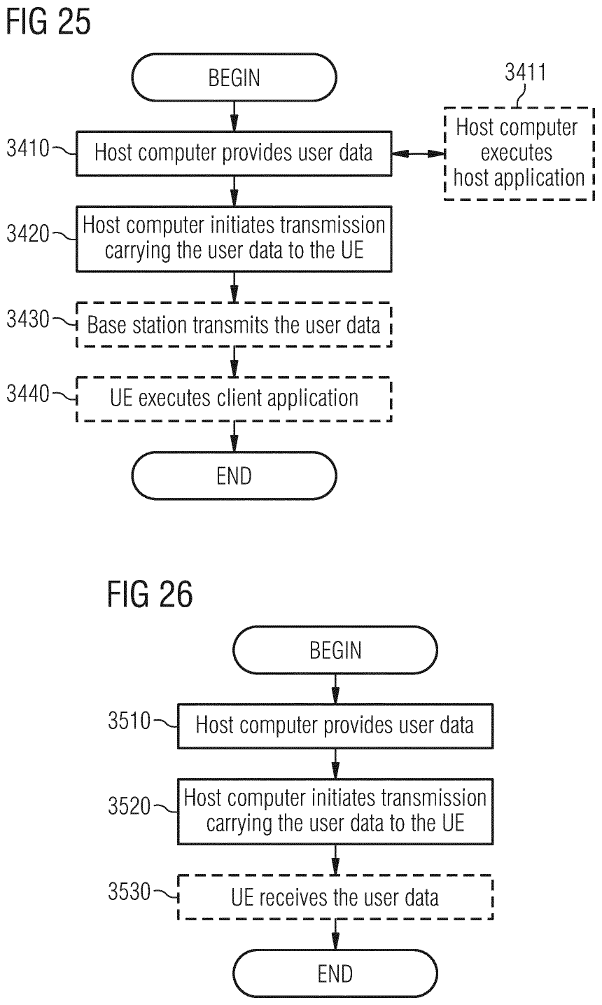

FIG. 27 is a flowchart illustrating a method implemented in a communication system, in accordance with one embodiment. The communication system includes a host computer, a base station such as a AP STA, and a UE such as a Non-AP STA which may be those described with reference to FIG. 19 and FIG. 24. For simplicity of the present disclosure, only drawing references to FIG. 27 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

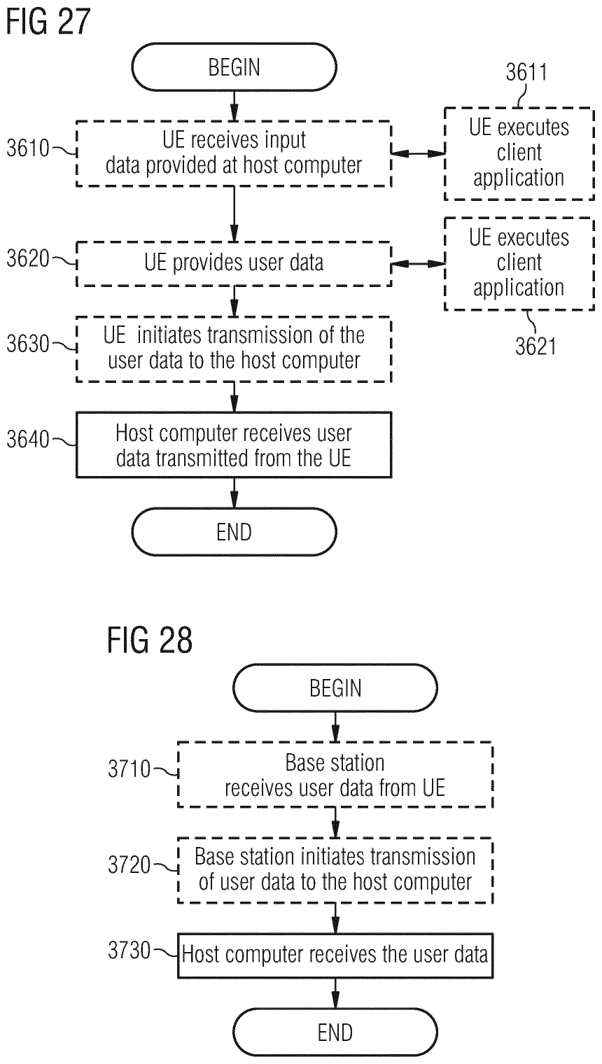

FIG. 28 is a flowchart illustrating a method implemented in a communication system, in accordance with one embodiment. The communication system includes a host computer, a base station such as a AP STA, and a UE such as a Non-AP STA which may be those described with reference to FIG. 19 and FIG. 24. For simplicity of the present disclosure, only drawing references to FIG. 28 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

| Abbreviation | Explanation |
|---|---|
| DC | Dual Connectivity |
| EN-DC | E-UTRA NR Dual Connectivity |
| LTE | Long Term Evolution |
| MN | Master Node |
| MR-DC | Multi-Radio Dual Connectivity |
| NR | New Radio |
| RRC | Radio Resource Control |
| SN | Secondary Node |
| UE | User Equipment |

1. A method performed by a network node for handling a multi connectivity configuration for a User Equipment, UE, resuming into connected mode from inactive mode in a wireless communications network, which UE was multi connected to a first radio node and a second radio node before it entered into inactive mode, the method comprising:
receiving a resume request from the UE,
deciding whether or not to trigger a role switch of any one or more out of: the first radio node and the second radio node for the multi connectivity configuration based on a certain condition, wherein the role switch comprises any one out of:
switching the role of the first radio node from Master Node, MN, to Secondary Node, SN, and
switching the role of the second radio node from SN to MN.

2. The method according to claim 1, wherein the MN is associated with a Master Cell Group, MCG, configuration, and wherein the SN is associated with a Secondary Cell Group, SCG, configuration.

3. The method according to claim 1, wherein any one or more out of:
switching the role of the first radio node from MN to SN, comprises: the MCG configuration associated with the first radio node becomes a basis for a new SCG configuration and
switching the role of the second radio node from SN to MN comprises: the SCG configuration associated with the second radio node becomes a basis for a new MCG configuration.

4. The method according to claim 1, wherein the certain condition comprises any one or more out of:
radio conditions between the UE and any one or more out of the first node and the second node,
radio conditions of any one out of the first node and the second node,
a triggering of a Radio Access Network, RAN, paging due to a data associated with a former SN terminated bearer, requiring a quick resume of the connection to the former SN,
load conditions associated with any one out of the first node and the second node,
an indication of which radio node the UE is resuming in.

5. The method according to claim 1, further comprising:
when decided to trigger a role switch of any one or more out of: the first node, and the second node in the multi connectivity configuration, sending to the UE, an indication about the decided role switch of the any one or more out of the radio first node and the second radio node in the multi connectivity configuration.

6. The method according to claim 1, wherein the indication about the decided role switch comprises any one or more out of: the MCG, and the SCG, associated to the corresponding role of the any one or more out of: the first radio node and the second radio node in the multi connectivity according to the decided role switch.

7. The method according to claim 1, wherein the network node is represented by any one out of:
the first radio node being the former MN,
the second radio node being the former SN, or
a third radio node.

8. The method according to claim 1, wherein the network node is represented by the first radio node being the former MN,
sending an indication to the second radio node being the former SN, which indication indicates a request for the decided role switch of any one out of the radio first node and the second radio node in the multi connectivity configuration, and
receiving an acknowledgement for the decided role switch from the second radio node being the former SN.

9. The method according to claim 1, wherein the network node is represented by the second radio node being the former SN,
sending an indication to the first radio node being the former MN, which indication indicates a request for the decided role switch of any one out of the radio first node and the second radio node in the multi connectivity set up, and
receiving an acknowledgement for the decided role switch from the first radio node being the former MN.

10. (canceled)

11. (canceled)

12. A method performed by a User Equipment, UE, for handling a multi connectivity configuration when resuming into connected mode from inactive mode in a wireless communications network, wherein the UE was multi connected to a first radio node and a second radio node before it entered into inactive mode, the method comprising:
sending a resume request message to a network node serving the UE,
receiving an indication from the network node, which indication indicates a role switch of any one or more out of the radio first node and the second radio node in the multi connectivity configuration, wherein the role switch comprises any one or more out of:
switching the role of the first radio node from Master Node, MN, to Secondary Node, SN, and switching the role of the second radio node from SN to MN.

13. The method according to claim 12, wherein the MN is associated with a Master Cell Group, MCG, configuration, and wherein the SN is associated with a Secondary Cell Group, SCG, configuration.

14. The method according to claim 12, wherein any one or more out of:
switching the role of the first radio node from MN to SN, comprises: the MCG configuration associated with the first radio node becomes a basis for a new SCG configuration and
switching the role of the second radio node from SN to MN comprises: the SCG configuration associated with the second radio node becomes a basis for a new MCG configuration.

15. The method according to claim 12, wherein the indication about the role switch comprises any one or more out of: the MCG, and the SCG, associated to the corresponding role being switched to of the any one or more out of: the first radio node and the second radio node in the multi connectivity according to the decided role switch.

16. (canceled)

17. (canceled)

18. A network node configured to handle a multi connectivity configuration for a User Equipment, UE, adapted to resume into connected mode from inactive mode in a wireless communications network, which UE was multi connected to a first radio node and a second radio node before it entered into inactive mode, wherein the network node further being configured to:
receive a resume request from the UE,
decide whether or not to trigger a role switch of any one or more out of: the first radio node and the second radio node for the multi connectivity configuration based on a certain condition, wherein the role switch is adapted to comprise any one out of:
switch the role of the first radio node from Master Node, MN, to Secondary Node, SN, and
switch the role of the second radio node from SN to MN.

19. The network node according to claim 18, wherein the MN is adapted to be associated with a Master Cell Group, MCG, configuration, and wherein the SN is adapted to be associated with a Secondary Cell Group, SCG, configuration.

20. The network node according to claim 18, wherein any one or more out of:
switch the role of the first radio node from MN to SN, comprises: the MCG configuration adapted to be associated with the first radio node becomes a basis for a new SCG configuration and
switch the role of the second radio node from SN to MN comprises: the SCG configuration adapted to be associated with the second radio node becomes a basis for a new MCG configuration.

21. The network node according to claim 18, wherein the certain condition is adapted to comprise any one or more out of:
radio conditions between the UE and any one or more out of the first node and the second node,
radio conditions of any one out of the first node and the second node,
a triggering of a Radio Access Network, RAN, paging due to a data associated with a former SN terminated bearer, requiring a quick resume of the connection to the former SN,
load conditions associated with any one out of the first node and the second node,
an indication of which radio node the UE is resuming in.

22. (canceled)

23. The network node according to claim 18, wherein the indication about the decided role switch is adapted to comprise any one or more out of: the MCG and the SCG, associated to the corresponding role of the any one or more out of: the first radio node and the second radio node in the multi connectivity according to the decided role switch.

24. The network node according to claim 18, wherein the network node is adapted to be represented by any one out of:
the first radio node being the former MN,
the second radio node being the former SN, or
a third radio node.

25. The network node according to claim 18, wherein the network node is adapted to be represented by the first radio node being the former MN, and wherein the network node further is configured to:
send an indication to the second radio node being the former SN, which indication indicates a request for the decided role switch of any one out of the radio first node and the second radio node in the multi connectivity configuration, and
receive an acknowledgement for the decided role switch from the second radio node being the former SN.

26. The network node according to claim 18, wherein the network node is adapted to be represented by the second radio node being the former SN, and wherein the network node further is configured to:
send an indication to the first radio node being the former MN, which indication indicates a request for the decided role switch of any one out of the radio first node and the second radio node in the multi connectivity set up, and
receive an acknowledgement for the decided role switch from the first radio node being the former MN.

27. A User Equipment, UE, configured to handle a multi connectivity configuration to resume into connected mode from inactive mode in a wireless communications network, wherein the UE is adapted to have been multi connected to a first radio node and a second radio node before it enters into inactive mode, wherein the UE further is configured to:
send a resume request message to a network node serving the UE,
receive an indication from the network node, which indication indicates a role switch of any one or more out of the radio first node and the second radio node in the multi connectivity configuration, wherein the role switch is adapted to comprise any one or more out of:
switching the role of the first radio node from Master Node, MN, to Secondary Node, SN, and switching the role of the second radio node from SN to MN.

28-30. (canceled)
